(19) United States
(12) Patent Application Publication
(10) Pub. No.: US 2026/0045743 A1
(43) Pub. Date: Feb. 12, 2026

(54) HIGH DENSITY, HIGH SPEED ELECTRICAL CONNECTOR AND SYSTEM THEREOF

(71) Applicant: Amphenol Commercial Products (Chengdu) Co., Ltd., Chengdu (CN)

(72) Inventors: Kui Yang, Chengdu (CN); Xiaodong HU, Chengdu (CN)

(73) Assignee: Amphenol Commercial Products (Chengdu) Co., Ltd., Chengdu (CN)

(21) Appl. No.: 19/294,521

(22) Filed: Aug. 8, 2025

(30) Foreign Application Priority Data
Aug. 9, 2024 (CN) 202411095453.7
Aug. 9, 2024 (CN) 202421932320.6

(51) Int. Cl. H01R 13/6581; H01R 12/71; H01R 13/05; H01R 13/502; H01R 13/6591

(52) U.S. Cl. CPC H01R 13/6581; H01R 13/05; H01R 13/502; H01R 13/6591; H01R 12/716

(57) ABSTRACT

High-density, high-speed electrical connectors and system thereof are provided. A connector can include a corrugated shield. The shield includes first portions forming recesses where one or more signal terminals can be disposed, and second portions connecting adjacent first portions. The second portions include beams configured for contacting complementary beams of a mating connector. Both the signal terminals and the beams of the shield are configured for two contact points. The shields are configured such that the shields of two mating connectors form enclosures around the mating contact portions (e.g., both of the two contact points). Power conductors, including power terminals and one or more pairs of power pin and power receptacle, can be symmetrically disposed. This configuration allows connectors with identical mating interfaces to reliably mate with each other, thereby enabling simplified and flexible system architecture while supporting high-speed operation, such as data rates of 224 Gbps and beyond.

### CROSS-REFERENCE TO RELATED APPLICATIONS

This application claims priority to and the benefit of Chinese Patent Application No. 202411095453.7, filed on Aug. 9, 2024. This application also claims priority to and the benefit of Chinese Patent Application No. 202421932320.6, filed on Aug. 9, 2024. The contents of these applications are incorporated herein by reference in their entirety.

### TECHNICAL FIELD

The present disclosure generally relates to interconnection systems, such as those including electrical connectors, used to interconnect electronic assemblies.

### BACKGROUND

Connectors are used in many electronic systems. It is generally easier and more cost effective to manufacture an electronic system as several printed circuit boards (PCB) which may be joined together with the connectors than to manufacture the electronic system as a single assembly. A traditional arrangement for interconnecting several PCBs is usually to have one PCB as a backplane. Then, other PCBs, which are referred to as “daughter boards” or “daughter cards”, are connected to the backplane through the connectors, thereby interconnecting these PCBs.

The electronic system generally has become smaller, quicker and more complex in functions. These changes mean that the number of circuits in the given area of the electronic system and the operation frequency of the circuits have been increased significantly in recent years. Current systems transfer more data between PCBs and require electrical connectors capable of transmitting signals at higher speeds than those of just a few years ago.

### SUMMARY

Aspects of the present disclosure relates to high-density, high-speed electrical connectors and systems thereof.

Some embodiments relate to an electrical connector. The electrical connector may include a housing comprising a wall elongated in a longitudinal direction; a plurality of terminals each comprising a mating contact portion, a tail, and an intermediate portion between the mating contact portion and the tail, the mating contact portions of the plurality of terminals disposed along the wall; and a shield comprising a plurality of first portions each comprising a recess such that one or more terminals of the plurality of terminals are disposed therein, and a plurality of second portions aligned with the plurality of terminals, each of the plurality of second portions connecting adjacent first portions of the plurality of first portions.

Optionally, the plurality of first portions are at least partially embedded in the wall of the housing.

Optionally, each of the plurality of second portions comprises a subportion connecting the adjacent first portions, and one or more beams extending from the subportion, the one or more beams aligned with the mating contact portions of the plurality of terminals.

Optionally, each of the plurality of second portions comprises one or more tails aligned with the tails of the plurality of terminals.

Optionally, the housing comprises a base; the wall protrudes from the wall; the plurality of second portions of the shield are fixedly held by the base of the housing; and the tails of the plurality of second portions of the shield extend beyond the base of the housing.

Optionally, the plurality of terminals are a plurality of pairs of first terminals disposed in the recesses of respective first portions of the plurality of first portions of the shield; and the electrical connector comprises one or more second terminals aligned with the plurality of terminals in the longitudinal direction and unshielded by the shield.

Optionally, the housing is an upper housing; and the electrical connector comprises a lower housing comprising a plurality of through-holes into which the tails of the plurality of terminals and the tails of the shield extend.

Optionally, the electrical connector may comprise a plurality of solder balls each attached to the tail of the shield or a respective terminal, wherein each of the plurality of solder balls is at least partially received in a respective through-hole of the plurality of through-holes of the lower housing.

Some embodiments relate to an electrical connector. The electrical connector may include a plurality of terminals each comprising a mating contact portion, a tail, and an intermediate portion between the mating contact portion and the tail, the plurality of terminals comprising a first plurality of terminals disposed in a first row and a second plurality of terminals disposed in a second row; a first shield comprising a plurality of first portions each comprising a recess such that one or more terminals of the first plurality of terminals are disposed therein, and a plurality of second portions aligned with the first plurality of terminals in a row direction, each of the plurality of second portions connecting adjacent first portions of the plurality of first portions; and a second shield comprising a plurality of first portions each comprising a recess such that one or more terminals of the second plurality of terminals are disposed therein, and a plurality of second portions aligned with the first plurality of terminals in a row direction, each of the plurality of second portions connecting adjacent first portions of the plurality of first portions.

Optionally, the electrical connector may comprise a housing comprising a wall elongated in the row direction, the wall comprising a first side and a second side opposite the first side; the first plurality of terminals are disposed on the first side of the wall; and the second plurality of terminals are disposed on the second side of the wall.

Optionally, the housing comprises a base, the wall protruding from the base, a plurality of first channels extending from the base into the wall in a mating direction perpendicular to the row direction, and a plurality of second channels located within the base and connecting adjacent first channels of the plurality of first channels.

Optionally, the housing comprises a plurality of third channels aligned with the plurality of second channels in the row direction; and the plurality of terminals are at least partially disposed in respective third channels of the plurality of third channels of the housing.

Optionally, the plurality of third channels comprise a plurality of pairs of third channels; each pair of the plurality of pairs of third channels is aligned with a first channel of the plurality of first channels; and the plurality of third channels comprise one or more third channels offset from the plurality of first channels.

Optionally, each of the plurality of terminals comprises a mating contact portion above the base of the housing, a tail extending below the base of the housing; and each of the plurality of second portions of the first and second shields comprises one or more beams above the base of the housing aligned with the mating contact portions of the plurality of terminals in a respective row of the first and second rows, and one or more tails extending below the base of the housing and aligned with the tails of the plurality of terminals in the respective row of the first and second rows.

Optionally, the plurality of first channels comprise a first plurality of first channels and a second plurality of first channels; and the plurality of second channels comprise a first plurality of second channels located within the base on the first side of the wall and connecting adjacent first channels of the first plurality of first channels, and a second plurality of second channels located within the base on the second side of the wall and connecting adjacent first channels of the second plurality of first channels.

Optionally, the plurality of first portions of the first shield are at least partially disposed in respective first channels of the first plurality of first channels of the housing; the plurality of second portions of the first shield are at least partially disposed in respective second channels of the first plurality of second channels of the housing; the plurality of first portions of the second shield are at least partially disposed in respective first channels of the second plurality of first channels of the housing; and the plurality of second portions of the second shield are at least partially disposed in respective second channels of the second plurality of second channels of the housing.

Optionally, the plurality of third channels comprise a first plurality of third channels aligned with the first plurality of second channels in row direction on the first side of the wall, and a second plurality of third channels aligned with a second plurality of second channels in the row direction on the second side of the wall; the first plurality of terminals are at least partially disposed in respective third channels of the first plurality of third channels of the housing; and the second plurality of terminals are at least partially disposed in respective third channels of the second plurality of third channels of the housing.

Some embodiments relate to an electrical connector. The electrical connector may include a housing comprising a base, a plurality of walls protruding from the base, each of the plurality of walls elongated in a longitudinal direction, and a plurality of spaces each between adjacent walls of the plurality of walls; a plurality of signal terminals disposed along the plurality of walls, each of the plurality of signal terminals comprising a mating contact portion curving into a space of the plurality of spaces; and a plurality of power terminals symmetrically disposed about a line extending in the longitudinal direction.

Optionally, the electrical connector may comprise a plurality of shields each comprising a plurality of first portions at least partially embedded in a wall of the plurality of walls of the housing and each corresponding to one or more signal terminals disposed along the wall, and a plurality of second portions aligned with the one or more signal terminals disposed along the wall, each of the plurality of second portions connecting adjacent first portions of the plurality of first portions.

Optionally, the electrical connector may comprise a power pin and a power receptacle symmetrically disposed about a line extending in the longitudinal direction; the housing comprises a rib elongated in the longitudinal direction and comprising a slot; and the power receptacle is disposed in the slot of the rib of the housing and configured to receive a power pin of a mating electrical connector having a mating interface identical to that of the electrical connector.

Some embodiments relate to an electrical connector is provided. The electrical connector may comprise: a housing assembly including a wall elongated in a longitudinal direction; a plurality of terminals including a plurality of pairs of first terminals arranged in a row parallel to the longitudinal direction; and a shield disposed on a side of the row and including a plurality of first portions corresponding to the plurality of pairs of first terminals and a plurality of second portions each connecting adjacent first portions. The plurality of first portions may be embedded in the wall and isolated from the plurality of pairs of first terminals by the wall.

Optionally, the housing assembly may include a mating interface and a mounting interface. Each of the plurality of terminals may include a mating contact portion extending to the mating interface and bent outside the wall and a mounting tail extending to the mounting interface. Each of the plurality of first portions may extend from the mounting interface at least to the mating contact portion of a respective pair of first terminals.

Optionally, each of the plurality of first portions may be recessed in a transverse direction perpendicular to the longitudinal direction to form a recess such that each of the plurality of pairs of first terminals is located at an opening of a respective recess.

Optionally, the recess may be configured to enclose a respective pair of first terminals with a shield of a mating electrical connector.

Optionally, the wall may include a first side surface and a second side surface opposite in the transverse direction. The row may include a first row disposed along the first side surface and a second row disposed along the second side surface. The shield may include a first shield and a second shield. A plurality of first portions of the first shield may be embedded in the first side surface, and a plurality of recesses formed by the plurality of first portions of the first shield may face the same direction as the first side surface. A plurality of first portions of the second shield may be embedded in the second side surface, and a plurality of recesses formed by the plurality of first portions of the second shield may face the same direction as the second side surface.

Optionally, the plurality of second portions may abut against the wall and be arranged in the row.

Optionally, the housing assembly may further include a base having a first surface and a second surface. The wall may be connected to the first surface. The wall and the first surface may form a mating interface. Each of the plurality of terminals may include a mating contact portion extending to the mating interface and bent outside the wall and a mounting tail extending beyond the second surface. The shield may be fixed to the base, and the plurality of first portions may extend from the base into the wall.

Optionally, each of the plurality of second portions may include: a connecting subportion connecting two adjacent first portions and fixed within the base; and a beam extending from the connecting subportion to the mating interface and bent outside the wall. The beam may be arranged in the row.

Optionally, each of the plurality of second portions may include: a connecting subportion connecting two adjacent first portions and fixed in the base; and a shield mounting tail extending from the connecting subportion beyond the second surface.

Optionally, the housing assembly may further include a lower housing attached to the second surface. The lower housing may comprise a plurality of through-holes through which the mounting tails of the plurality of terminals and the shield mounting tails of the shield respectively pass. A solder ball may be connected to each of the mounting tails of the plurality of terminals and the shield mounting tails of the shield. At least a portion of the solder ball may be received in a respective through-hole.

Optionally, the connecting subportion may extend beyond the first surface in a direction toward the mating interface.

Optionally, the housing assembly further may include a shield mounting channel having: a plurality of first channel portions each extending from the base into the wall in a mating direction perpendicular to the longitudinal direction and a plurality of second channel portions each located within the base and connecting adjacent first channel portions. Each of the plurality of first channel portion may have a U-shaped cross-section. The plurality of first portions of the shield may be mounted into the plurality of first channel portions respectively. The plurality of second portions may be mounted into the plurality of second channel portions respectively.

Optionally, the housing assembly may further include a plurality of terminal mounting channels. The shield mounting channel and the plurality of terminal mounting channels both may extend to the second surface of the base. The shield and the plurality of terminals may be respectively mounted into the shield mounting channel and the plurality of terminal mounting channels from the second surface.

Optionally, the housing assembly may further include a lower housing attached to the second surface such that the shield and the plurality of terminals are sandwiched between the base and the lower housing.

Optionally, the first surface and the second surface may be opposite in a mating direction perpendicular to the longitudinal direction.

Optionally, the plurality of pairs of first terminals may be arranged in a plurality of the rows parallel to the longitudinal direction. The plurality of the rows may be spaced apart in a transverse direction perpendicular to the longitudinal direction. For any two adjacent rows, one row may be offset from the other row in the longitudinal direction such that pairs of first terminals in one row are staggered from pairs of first terminals in the other row.

Optionally, the housing assembly may include a plurality of the walls. The plurality of the walls may be arranged at equal intervals in a transverse direction perpendicular to the longitudinal direction. Each of opposite side surfaces of adjacent walls may be provided with the row and the shield. A space between two rows on opposite side surfaces of adjacent walls may be configured to receive an identical wall and two identical rows on two sides thereof.

Optionally, the housing assembly may have a first edge and a second edge opposite in the transverse direction. The first edge and the second edge complementary in structure may enable the electrical connector to mate with another identical electrical connector.

Optionally, the first edge may include a rib elongated in the longitudinal direction. The plurality of the walls may be arranged from a position adjacent to the rib to the second edge. A positioning slot may be enclosed by the rib and a wall adjacent to the rib, and a wall on the second edge is shaped to be insertable into the positioning slot such that when the electrical connector is mated with the another identical electrical connector, the positioning slot on one of the electrical connector and the another identical electrical connector receives the wall on the second edge of the other of the electrical connector and the another identical electrical connector.

Optionally, the wall on the second edge may be provided with the row only on a side surface facing an adjacent wall, and the remaining walls may be provided with the rows on two opposite sides in the transverse direction.

Optionally, the first edge may include a positioning post provided with a positioning hole, and the second edge may include a positioning pin shaped to be insertable into the positioning hole such that when the electrical connector is mated with the another identical electrical connector, the positioning pin on one of the electrical connector and the another identical electrical connector is inserted into the positioning hole on the other of the electrical connector and the another identical electrical connector.

Optionally, the positioning pin may be configured as a first power terminal, and the positioning post may be connected with a second power terminal.

Optionally, the plurality of terminals may further include a plurality of second terminals arranged in the row. The plurality of second terminals may have no shield on a side thereof.

Some embodiments relate to an electronic system. The electronic system may include a first electrical connector and a second electrical connector that are mutually mateable. Each of the first electrical connector and the second electrical connector may include: a plurality of pairs of terminals arranged in a row parallel to a longitudinal direction; and a shield disposed on a side of the row, the shield including a plurality of first portions corresponding to the plurality of pairs of first terminals and a plurality of second portions each connecting adjacent first portions. When the first electrical connector is mated with the second electrical connector, the plurality of pairs of terminals of the first electrical connector and the plurality of pairs of terminals of the second electrical connector may be in electrical contact respectively, and the second portions of the shield of the first electrical connector and the second portions of the shield of the second electrical connector may be in electrical contact respectively. Any two pairs of terminals in electrical contact may be enclosed and shielded by respective first portions of the shields of the first electrical connector and the second electrical connector.

Optionally, for each of the first electrical connector and the second electrical connector: each of the plurality of pairs of terminals may include a mating contact portion and a mounting tail opposite in an extension direction of the terminals. Each of the plurality of first portions may extend from a mounting interface of a respective electrical connector at least to the mating contact portion of a respective pair of terminals.

Optionally, for each of the first electrical connector and the second electrical connector: each of the plurality of first portions may be recessed in a transverse direction perpendicular to the longitudinal direction to form recesses such that when the first electrical connector is mated with the second electrical connector, openings of the recesses of the first electrical connector face openings of the recesses of the second electrical connector.

Optionally, the first electrical connector and the second electrical connector may be identical in structure.

Some embodiments relate to an electronic system. The electronic system may include a first electrical connector having a mating interface and a second electrical connector having a mating interface mateable with the mating interface of the first electrical connector. The mating interface of the first electrical connector may be identical to the mating interface of the second electrical connector in structure.

Optionally, each of the first electrical connector and the second electrical connector may have a mounting interface opposite to a respective mating interface. The mounting interface of the first electrical connector may be identical to the mounting interface of the second electrical connector in structure.

Optionally, the first electrical connector and the second electrical connector may have the same or different heights.

Some embodiments relate to a method for manufacturing an electrical connector. The method may comprise the steps of inserting a plurality of terminals arranged in a row parallel to a longitudinal direction and a shield into an upper housing from a bottom of the upper housing in a mating direction perpendicular to the longitudinal direction; attaching a lower housing to the bottom of the upper housing; and securing the lower housing to the upper housing by hot riveting.

Optionally, the lower housing may comprise a plurality of through-holes, each of the plurality of terminals and the shield may have a mounting tail inserted into a respective one of the plurality of through-holes. The method may include attaching a plurality of solder balls to mounting tails of the plurality of terminals and the shield respectively, at least a portion of each solder ball being received in a respective through-hole.

Optionally, the upper housing may include: a base having a first surface and a second surface opposite in the mating direction; and a wall disposed on the first surface and elongated in the longitudinal direction. The wall and the first surface may form a mating interface. The plurality of terminals each may have a mating contact portion extending to the mating interface. The plurality of terminals may be inserted into the base and the wall, and the shield may be inserted into the base and extends into the mating interface.

Optionally, the upper housing may include a plurality of terminal mounting channels extending from the second surface through the base into the wall. The plurality of terminal mounting channels may open into the mating interface. The plurality of terminals may be inserted into the plurality of terminal mounting channels.

Thus, the first terminals for transmitting high-speed signals in the first electrical connector can be shielded by the shield on a side thereof, which significantly enhances the anti-interference capability of the first electrical connector. In other words, the shield of the present disclosure is arranged parallel to a row of the pairs of first terminals and separated from the pairs of first terminals by a wall. This achieves a more uniform shielding effect, while the wall also limit the distance between the shield and signal terminals and effectively prevent the signal terminals from contacting the shield. As a result, compared with other electrical connectors, signal integrity can be improved during high-frequency signal transmission of the first electrical connector.

A series of simplified concepts are introduced in the Summary of the Invention, which will be further described in detail in the Detailed Description section. The Summary of the Invention is not intended to identify key features or essential features of the claimed technical solutions, nor is it intended to determine the protection scope of the claimed technical solutions.

The techniques described herein may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system, according to some embodiments, with a bottom portion cut away for clarity.

FIG. 2 is another perspective view of the electronic system shown in FIG. 1.

FIG. 3 is a perspective view of the electronic system shown in FIG. 1, with first and second electrical components hidden and showing first and second electrical connectors.

FIG. 4A is a perspective view of the first electrical connector shown in FIG. 3, with a right portion cut away for clarity.

FIG. 4B is a bottom view of the portion of the first electrical connector of FIG. 4A with a lower housing hidden.

FIG. 4C is a bottom view of the portion of the first electrical connector of FIG. 4A with terminals and a shield hidden.

FIG. 4D is an enlarged perspective view of a circled portion of the first electrical connector of FIG. 4A.

FIG. 4E is an enlarged view of a circled portion of the first electrical connector of FIG. 4B.

FIG. 5 is a partially enlarged perspective view of the first electrical connector of FIG. 4A, with an upper housing hidden.

FIG. 6A is a perspective view of the first electrical connector of FIG. 4A, showing two rows of terminals, each row including a shield, with other components hidden.

FIG. 6B is a perspective view of one row of terminals, including the shield, as shown in FIG. 6A.

FIG. 6C is another perspective view of the row of terminals, including the shield, as shown in FIG. 6B.

FIG. 6D is a perspective view of the shield shown in FIGS. 6B-6C.

FIG. 7A is a top view of the first electrical connector of FIG. 4A, showing rows of terminals with respective shields, with other components hidden.

FIG. 7B is a top view of the first electrical connector of FIG. 4A mated with the second electrical connector, showing rows of terminals with respective shields, with other components hidden.

FIG. 8A is an enlarged view of a circled portion of the first electrical connector shown in FIG. 7A.

FIG. 8B is an enlarged view of a circled portion of the mated first and second electrical connectors shown in FIG. 8B.

FIG. 9A is a cross-sectional perspective view of the first electrical connector shown in FIG. 3.

FIG. 9B is a cross-sectional perspective view of the first and second electrical connectors shown in FIG. 3, shown in a mated condition.

FIG. 10A is an enlarged perspective view of a circled portion of the first electrical connector of FIG. 9A.

FIG. 10B is an enlarged perspective of a circled portion of the mated first and second electrical connectors of FIG. 9B.

FIG. 11A is a bottom perspective view of the first electrical connector shown in FIG. 3.

FIG. 11B is an enlarged perspective view of a circled portion of the first electrical connector shown in FIG. 11A.

### DETAILED DESCRIPTION

The inventors have recognized and appreciated design techniques for high-density electrical connectors that can reliably mate with another connector having an identical mating interface, while supporting high-speed operation, such as 224 Gbps and beyond. With the continued development of advanced technologies such as artificial intelligence (AI), fifth-generation (5G) and 5.5G communications, there is an increasing demand for electrical connectors that offer higher transmission rates and greater density. Techniques described herein provide high-density hermaphroditic connectors configured to support both precise alignment and reliable signal and/or power transmission, thereby enabling both simplified and flexible system architectures. The hermaphroditic design allows two identical connectors to mate with each other, reducing the need for separate male and female connectors. This commonality enables the use of the same molds and tooling for both mating connectors, lowering manufacturing costs, simplifying inventory, and improving production scalability.

According to aspects of the present disclosure, an electrical connector can include a corrugated shield. The shield may include first portions forming recesses where one or more signal terminals can be disposed, and second portions connecting adjacent first portions. The second portions may include beams configured for contacting complementary beams of a mating connector. Both the signal terminals and the beams of the shield may be configured for mating with identical terminals and beams at two contact points. The shields may be configured such that the shields of two mating connectors form enclosures around the mating contact portions (e.g., both of the two contact points). Power conductors, including power terminals and one or more pairs of power pin and power receptacle, can be symmetrically disposed across a centerline extending in the row direction of the connector. In some embodiments, the connector may accommodate up to 216 differential signal pairs, or alternatively, 199 differential pairs in combination with 70 power terminals. Additionally, the connector may include two pairs of power pins and power receptacles, each power pin/receptacle rated to carry up to 5 A, thereby supporting systems with high current requirements.

In some embodiments, the high-density electrical connector may include a housing assembly, a plurality of pairs of first terminals for transmitting differential signals, and a shield. The plurality of pairs of first terminals are held in the housing assembly and arranged in a row parallel to a longitudinal direction. The housing assembly includes a wall elongated in the longitudinal direction, and the first terminals may be disposed along the wall. The shield may include a plurality of first portions corresponding to respective pairs of first terminals and a plurality of second portions each connecting adjacent first portions. The plurality of first portions are embedded in the wall and spaced apart from respective pairs of first terminals, thereby providing shielding for respective pairs of first terminals. Exemplarily, the plurality of second portions each is located between adjacent pairs of first terminals and arranged in the row of the first terminals. The shield may be corrugated. The shield may include recesses corresponding to the differential signal pairs, and the openings of the recesses may face respective differential signal pairs, such that the shield can provide shielding for the differential signal pairs on three sides.

Exemplarily, the pairs of first terminals each may include a mating contact portion bent outside the wall at a mating interface of the electrical connector and a mounting tail extending to a mounting interface of the electrical connector. The plurality of first portions may extend from the mounting interface of the electrical connector to the mating contact portions of respective pairs of first terminals, thereby enhancing the shielding effect. Exemplarily, the second portions each may include a connecting subportion joining adjacent first portions and a beam extending from the connecting subportion toward the mating interface. The beam may be in electrical contact with a shield on a mating electrical connector. Exemplarily, the second portions each may further include a shield mounting tail connected to the connecting subportion. The shield mounting tail may extend to the mounting interface of the electrical connector for electrical connection with an electrical component such as a printed circuit board. Exemplarily, the shield mounting tail may have the same structure as that of the mounting tail of the first terminal, so as to connect to the printed circuit board in the same manner. Exemplarily, the shield mounting tails and the mounting tails of the first terminals are soldered to contact pads on the printed circuit board using a ball grid array (BGA) process.

Exemplarily, the beam may be used as a grounding terminal. Compared to separately providing a grounding terminal, the assembling process can be simplified by integrating the grounding terminal on the shield. Additionally, the electrical connection reliability and the structural strength can be enhanced.

Exemplarily, the housing assembly may include an upper housing and a lower housing. The upper housing includes a base, and the aforementioned wall is disposed on a first surface of the base to form the mating interface. The lower housing is connected to a second surface of the base to form the mounting interface. The lower housing may comprise a plurality of through-holes corresponding to the shield mounting tails and the mounting tails of the first terminals.

The shield mounting tails and the mounting tails of the first terminals may not extend beyond respective through-holes. At least a portion of each of the solder balls connected to the mounting tails is received in a respective through-hole. Exemplarily, the terminals and the shield are mounted from the second surface into respective channels in the upper housing. After the lower housing is connected to the upper housing, the terminals and the shield can be held between the upper housing and the lower housing. The lower housing may be configured to facilitate the insertion of both signal terminals and shielding structures into the housing from the same side. This not only simplifies the assembly process but also provides a surface that controls the amount of solder, which enhances reliable solder mounting.

Exemplarily, the electrical connector may further include second terminals, which are arranged in the row of the first terminals along the wall. The second terminals may be configured to transmit low-speed signals and/or power signals. The current carried by the power signals may be relatively small. There is no shield around the second terminals. Mating positioning structures, such as positioning pin and positioning hole, may be provided at an edge and/or a corner of the electrical connector. The positioning structures may also carry relatively larger currents.

The inventors have recognized and appreciated that at least the mating interface of the electrical connector may be configured to be complementary in structure with respect to a center line parallel to the longitudinal direction, or at least the mating interface of the electrical connector may be configured to be complementary in structure with respect to a center line parallel to a transverse direction perpendicular to the longitudinal direction. It enables another electrical connector that is identical to the electrical connector at least at the mating interface to mate with the electrical connector. Exemplarily, two mating electrical connectors may be substantially the same in structure, with the difference possibly including different heights along a mating direction of the electrical connector. This design reduces part types, lowering management costs and complexities. Exemplarily, the electrical connector is complementary with respect to a center line parallel to the longitudinal direction. In this case, an odd number of rows of terminals may be provided, and multiple walls may be arranged at intervals along the transverse direction. The housing assembly may include first and second edges opposite in the transverse direction. The first edge may be provided with a rib elongated in the longitudinal direction. The walls may be arranged from a position adjacent to the rib to the second edge.

Exemplarily, a positioning slot may be formed between the rib and an adjacent wall, and a wall on the second edge may match with the positioning slot in shape. Exemplarily, the wall on the second edge may have terminals only on one side, while the remaining walls may have terminals on both sides. Exemplarily, the spacing between adjacent walls may receive a wall of another electrical connector and terminals along the wall of another electrical connector. Exemplarily, the positioning pin and positioning hole of the connector that match with each other may be symmetrically disposed with respect to the center line.

Exemplarily, if two mating connectors are identical in structure at least at the mating interface, any two pairs of contacting first terminals of the two connectors may be substantially enclosed from four sides by the first portions of their shields, and may be further shielded by the second portions.

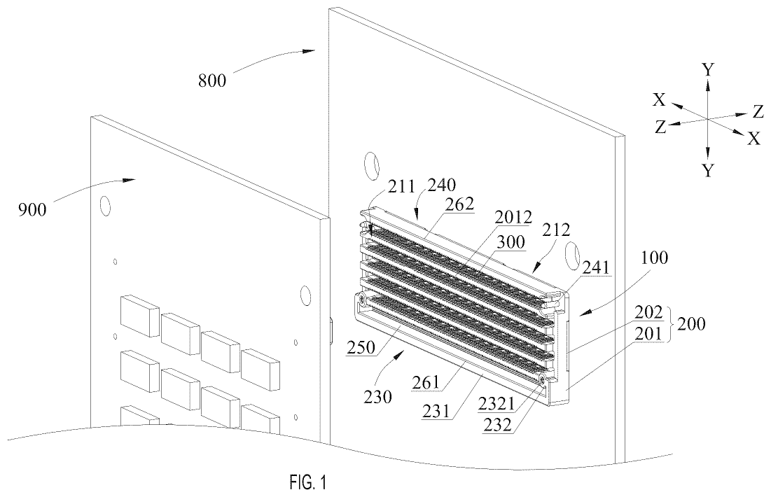

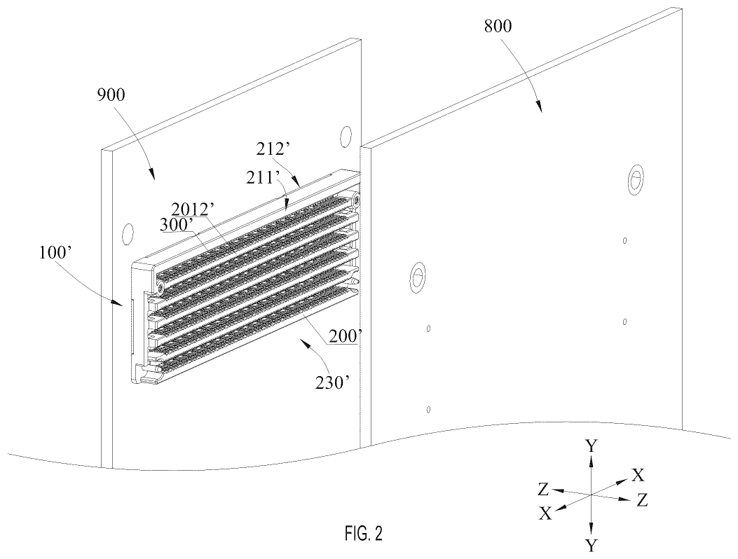

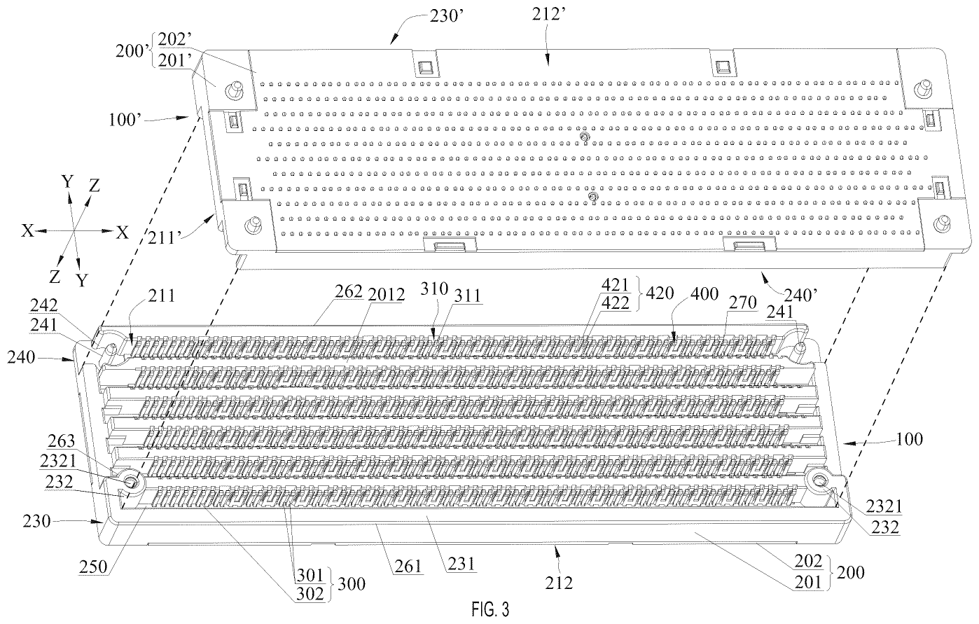

FIGS. 1-2 both show a part of an electronic system according to an exemplary embodiment of the present disclosure. The electronic system may include a first electrical connector 100 and a second electrical connector 100′. The first electrical connector 100 may be configured to be mounted on a first electrical component 800. Exemplarily, the first electrical component 800 may be configured as a printed circuit board, such as a daughter board, backplane and mid-plane, or any other suitable electrical component. The first electrical connector 100 may be electrically connected to the first electrical component 800. The second electrical connector 100′ may be configured to be mounted on a second electrical component 900. Exemplarily, the second electrical component 900 may be configured as a printed circuit board, such as a daughter board, backplane and mid-plane, or any other suitable electrical component. The second electrical connector 100′ m ay be configured to mate with the first electrical connector 100 along a mating direction, thereby electrically connecting the first electrical component 800 with the second electrical component 900 through the first electrical connector 100 and the second electrical connector 100′. The second electrical connector 100′ may be detachably connected to the first electrical connector 100. The first electrical component 800 and the second electrical component 900 are hidden in FIG. 3 to show the first electrical connector 100 and the second electrical connector 100′.

Exemplarily, as shown in FIGS. 1 and 3, the first electrical connector 100 may be a vertical connector including a first mating interface 211 and a first mounting interface 212 opposite along the mating direction. The terminals of the first electrical connector 100 may extend from the first mating interface 211 to the first mounting interface 212. The first mating interface 211 may be configured to mate with the second electrical connector 100′. The first mounting interface 212 of the first electrical connector 100 may be configured to be mounted to the first electrical component 800, such that the first electrical component 800 may be electrically connected to the first electrical connector 100. The first mounting interface 212 may be mounted to the first electrical component 800 by soldering or pressure mounting.

Exemplarily, the first electrical connector 100 may also be fixed to the first electrical component 800 by other suitable mechanical structures such as guides or fasteners. Optionally, the first electrical connector 100 may be a right-angle connector with a first mating interface and a first mounting interface perpendicular to each other. Optionally, the first electrical connector 100 may be an orthogonal connector with a first mating interface and a first mounting interface orthogonal to each other.

Exemplarily, as shown in FIGS. 2 and 3, the second electrical connector 100′ may be a vertical connector including a second mating interface 211′ and a second mounting interface 212′ opposite along the mating direction. The terminals of the second electrical connector 100′ may extend from the second mating interface 211′ to the second mounting interface 212′. The terminals of the first electrical connector 100 and second electrical connector 100′ may be electrically connected by mating the second mating interface 211′ with the first mating interface 211 of the first electrical connector 100. The second mounting interface 212′ of the second electrical connector 100′ may be configured to be mounted to the second electrical component 900, such that the second electrical connector 100′ is electrically connected to the second electrical component 900. Thereby, the first electrical component 800 may be electrically connected with the second electrical component 900 through the first electrical connector 100 and the second electrical connector 100′. The second mounting interface 212′ may be mounted to the second electrical component 900 by soldering or pressure mounting. Exemplarily, the second electrical connector 100′ may also be fixed to the second electrical component 900 by other suitable mechanical structures such as guides or fasteners. Optionally, the second electrical connector 100′ may be a right-angle connector with a second mating interface and a second mounting interface perpendicular to each other. Optionally, the second electrical connector 100′ may be an orthogonal connector with a second mating interface and a second mounting interface orthogonal to each other.

Exemplarily, a mezzanine connector assembly may be formed by the first electrical connector 100 and the second electrical connector 100′. Exemplarily, one of the first electrical connector 100 and the second electrical connector 100′ may be configured as a socket connector, and the other may also be configured as a plug connector. Exemplarily, each of the first electrical connector 100 and the second electrical connector 100′ may be configured as a hermaphroditic electrical connector. Based on this, portions of the terminals of the first electrical connector 100 at the first mating interface 211 may be configured identical or similar to portions of the terminals of the second electrical connector 100′ at the second mating interface 211′.

Exemplarily, the portions of the terminals of the two connectors respectively at the first mating interface 211 and the second mating interface 211′ may be mirror images of each other in configuration. Optionally, the other portions of the first electrical connector 100 and the second electrical connector 100′ may have the same or similar configurations. Optionally, although each of the first electrical connector 100 and the second electrical connector 100′ may be configured as a hermaphroditic electrical connector, the first electrical connector 100 and the second electrical connector 100′ may be respectively configured as different types of connectors, such as vertical connector, right-angle connector, and orthogonal connector. Optionally, the first electrical connector 100 and the second electrical connector 100′ may be of the same type.

The first electrical connector 100 and the second electrical connector 100′ according to some embodiments are described in detail hereinafter with reference to the drawings. For clarity and brevity of description, a mating direction Z-Z, a longitudinal direction X-X, and a transverse direction Y-Y may be indicated in the drawings, wherein any two of the mating direction Z-Z, the longitudinal direction X-X, and the transverse direction Y-Y may be perpendicular to each other. The mating direction Z-Z may refer to the height direction of the electrical connector. The longitudinal direction X-X may refer to the length direction of the electrical connector. The transverse direction Y-Y may refer to the width direction of the electrical connector.

As shown in FIG. 3, the first electrical connector 100 may include a housing assembly 200. The housing assembly 200 may be formed of an insulating material, such as plastic, by molding. The housing assembly 200 may be a one-piece member. Exemplarily, the housing assembly 200 may be substantially in a strip elongated in the longitudinal direction X-X or in a sheet parallel to the longitudinal direction X-X and the transverse direction Y-Y where the first electrical connector 100 is a vertical connector. The first electrical connector 100 may include a plurality of terminals 300. The plurality of terminals 300 may be held by the housing assembly 200. For example, at least portions of the terminals 300 may be embedded in the housing assembly 200. The terminals 300 may be spaced apart on the housing assembly 200 in the longitudinal direction X-X, such that adjacent terminals 300 are electrically insulated from each other. The terminals 300 may be made of a conductive material, such as metal. The terminals 300 each may be a one-piece member elongated generally along the mating direction Z-Z. The housing assembly 200 may include a plurality of walls 2012 elongated along the longitudinal direction X-X, such as 2012a, 2012b, 2012c, 2012d, 2012e, and 2012f. The plurality of walls 2012 may be arranged along the transverse direction Y-Y at intervals. The walls 2012 may support and position the second electrical connector 100′ mated to the first electrical connector 100. The walls 2012 also separate the terminals 300 along the transverse direction Y-Y. The plurality of terminals 300 may be arranged in multiple rows along the plurality of walls 2012 respectively. Exemplarily, at least a portion of the walls 2012 each may have rows of terminals 300 on the two sides opposed along the transverse direction Y-Y. Two rows of terminals 300 between adjacent walls may be spaced apart by a sufficient distance such that the two rows of terminals 300 are insulated from each other and corresponding terminals of the second electrical connector 100′ may also be inserted between two rows of terminals 300. Exemplarily, for two outermost walls in the transverse direction Y-Y, such as 2012a and 2012f, one or both of them may have a row of terminals 300 only on a side facing inner walls 2012b, 2012c, 2012d, and 2012e. In some embodiments, the housing assembly 200 may also include only one wall.

The plurality of terminals 300 may include a plurality of pairs of first terminals 301, which may be arranged in the aforementioned rows and spaced apart from each other. High-speed differential signals may be transmitted through the pairs of first terminals 301, so as to increase the data rate and effectively alleviate the common-mode interference. The differential signals may be obtained by detecting voltage differences in differential pairs of the first terminals 301. High-speed signals may include high-data-rate signals (e.g., signals with a data rate exceeding 25 Gb/s in the case of PAM4 encoding) and/or high-frequency signals (e.g., exceeding 56 or 112 Gb/s). The first terminals 301 may mate with corresponding terminals of the second electrical connector 100′ along the mating direction. The first terminals 301 may extend generally along the mating direction. The extension direction of each of the first terminals 301 is its length direction. Optionally, mating terminals of the first electrical connector 100 and second electrical connector 100′ may bend toward each other to exert a certain normal pressure, such that the first terminals 301 can be reliably electrically connected to corresponding terminals of the second electrical connector 100′ and the second electrical connector 100′ can be held in place.

External electromagnetic interference (EMI) is mitigated, and signal integrity is effectively enhanced by adopting differential signaling. On this basis, the first electrical connector 100 may further include a shield 400. The shield 400 may be made of a conductive material, such as metal or lossy material. Induced currents may be generated in the shield 400 when applied by an external electromagnetic field, thereby generating a magnetic field to counteract external interference. The shield 400 may block external interference from one or more directions toward the first terminals 301, and may also prevent interference signals emitted by the first terminals 301 from radiating to the exterior. Exemplarily, the shield 400 may be connected to a ground or power plane in the first electrical component 800 for providing a reference potential, to prevent common-mode interference from coupling to the first terminals 301. The shield 400 may be disposed on the sides of the rows of the terminals 300. The shield 400 may include a plurality of first portions 410 disposed corresponding to respective pairs of first terminals 301 and a plurality of second portions 420 each connected between adjacent first portions 410. The first portions 410 may mainly provide shielding for the first terminals 301. The second portions 420 may connect the plurality of first portions 410 together, which can prevent poor grounding of some first portions 410 (if any) and enable the shield 400 to be integrally and easily installed in the first electrical connector 100. In some cases, the second portions 420 can also provide shielding for the first terminals 301 to a certain extent.

To achieve a better shielding effect, the first portions 410 each may extend as long as possible along an extension direction of a corresponding first terminal 301. The first portions 410 may be embedded in respective walls 2012 and isolated from the pairs of first terminals 301 by the walls 2012. This can effectively prevent the first portions 410 from electrically contacting the first terminals 301 if the first terminals 301 are deformed under the normal pressure from the second electrical connector 100′. Also, the spacing between the first portions 410 and the first terminals 301 can also be maintained by the walls 2012, thereby improving the shielding effect. The first electrical connector 100 may be mounted to the first electrical component 800, thereby enabling reliable transmission of high-speed signals between the first electrical component 800 and the second electrical component 900 through the first electrical connector 100 and the second electrical connector 100′.

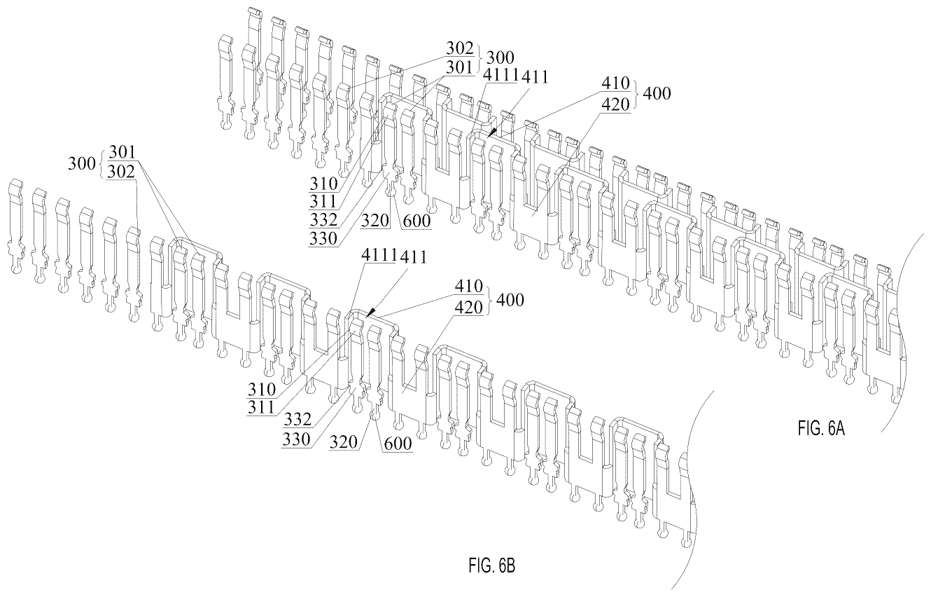

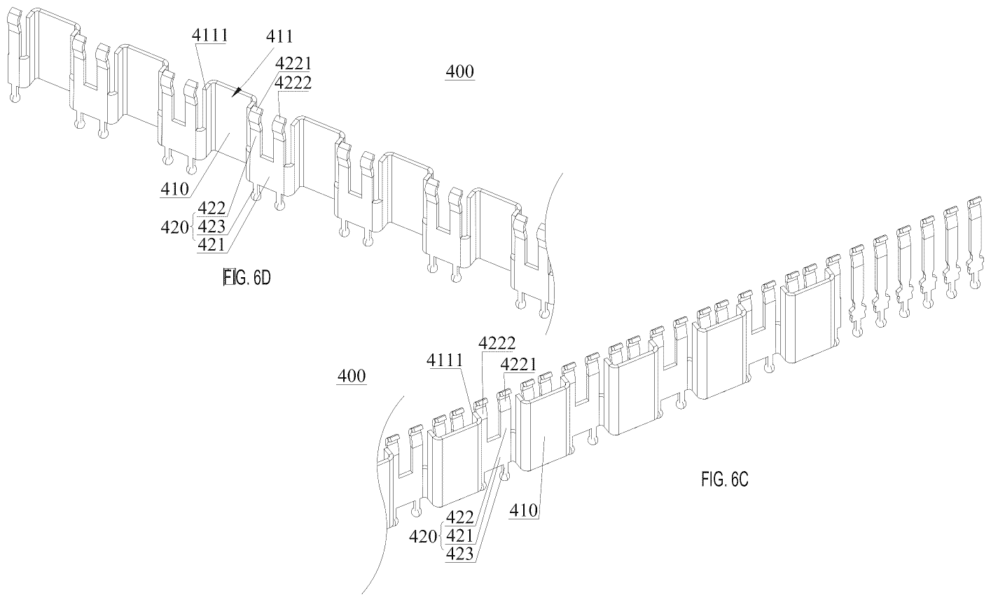

Exemplarily, the first mating interface 211 and the first mounting interface 212 may be formed by the housing assembly 200. With reference to FIGS. 6A to 6D, 9A to 9B, and 10A, each terminal 300 may include a mating contact portion 310 and a mounting tail 320 opposed along the extension direction. The mating contact portion 310 is used to electrically contact a respective terminal 300′ of the second electrical connector 100′. The mating contact portion 310 extends to the first mating interface 211 and is bent outside the wall 2012. The mounting tail 320 of the terminal 300 may extend to the first mounting interface 212 for connection to the first electrical component 800. The first mounting interface 212 may be considered as a part of the first electrical connector 100 mating with the first electrical component 800. For example, referring back to FIG. 3, the first mounting interface 212 may include a flat surface fitting to the surface of the first electrical component 800 and recesses recessed from the flat surface. The mounting tails 320 of the terminals 300 extend into the recesses to electrically connect with the first electrical component 800. The mating contact portions 310 of the terminals 300 may extend to the first mating interface 211, for electrically contacting with respective terminals of the second electrical connector 100′. The intermediate portions of the terminals 300 joining the mating contact portions 310 and the mounting tails 320 may be wrapped or embedded in the housing assembly 200, and thus the terminals 300 may be fixed in the housing assembly 200.

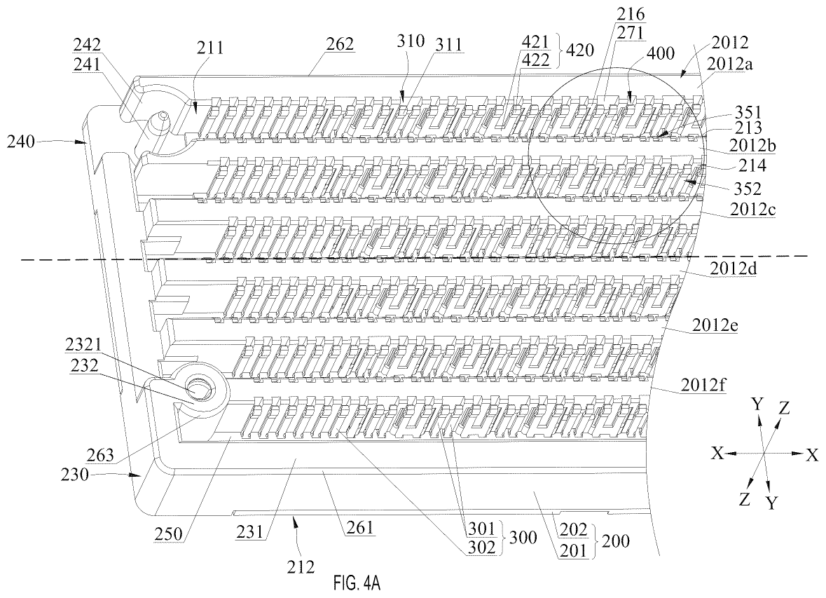

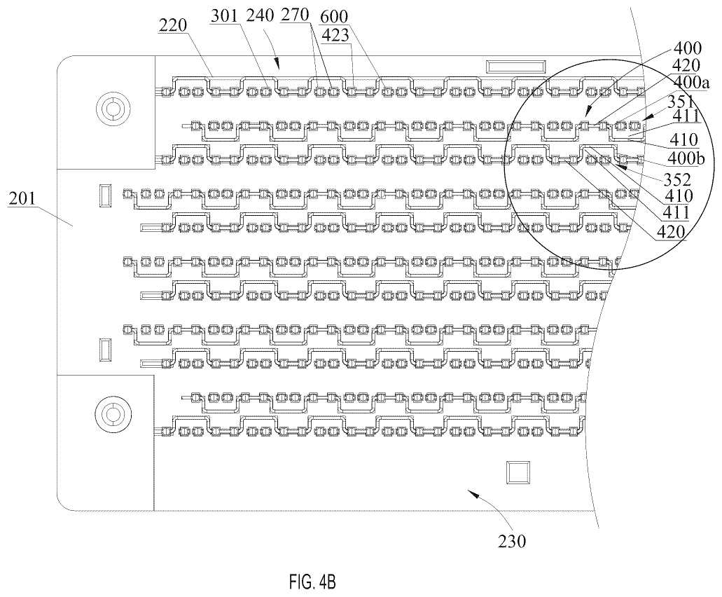

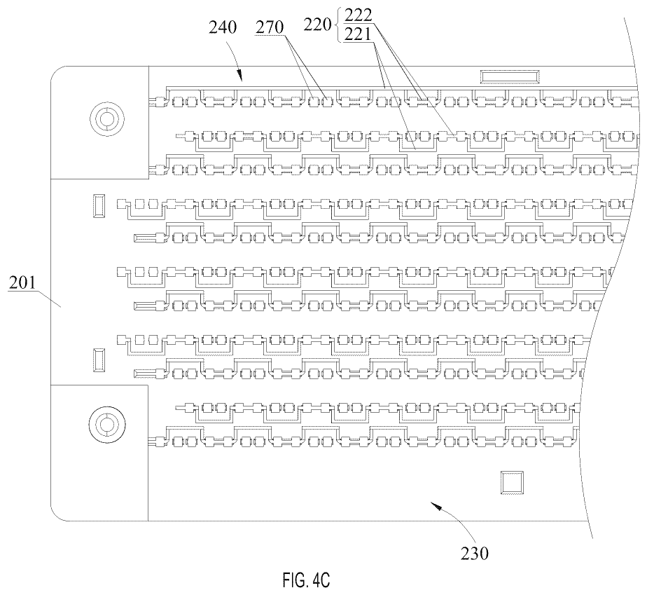

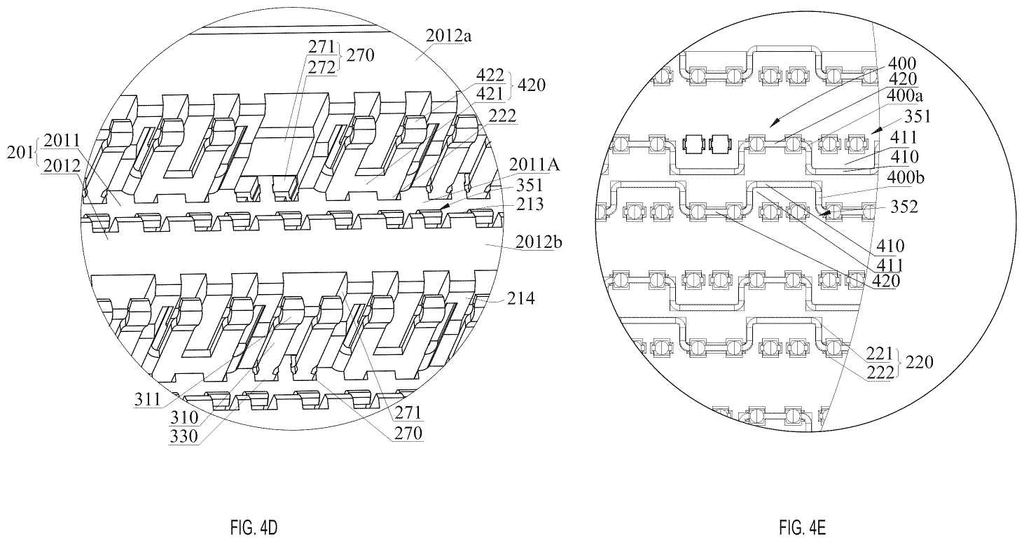

The first portions 410 each may extend from the first mounting interface 212 at least to mating contact portions 310 of a respective pair of first terminals 301 within a respective wall 2012. As shown in FIG. 4A, grooves 271 may be provided in an outer side surface of each of the walls 2012. A pair of first terminals 301 is hidden from FIG. 4D to show a groove 271. The grooves 271 may extend from the first mating interface 211 of the housing assembly 200 toward the first mounting interface 212, but be spaced apart from the first mounting interface 212. The mating contact portions 310 of each pair of the first terminal 301 may extend into a respective groove 271 and be bent outside a respective wall 2012. The mating contact portions 310 each may include an electrical contact surface 311 bent outside the wall 2012. When the first electrical connector 100 is mated with the second electrical connector 100′, the terminals 300′ of the second electrical connector 100′ may pressure the mating contact portions 310 of the terminals 300 of the first electrical connector 100 toward the grooves 271 along the transverse direction Y-Y, such that the terminals 300 are elastically deformed. The terminals 300 of the first electrical connector 100 may abut against and electrically contact the terminals 300′ of the second electrical connector 100′ reliably.

As shown in FIG. 3, the mounting tails 320 of the first electrical connector 100 may be shaped to be flexible for pressure mounting. The first electrical component 800 may comprise a plurality of contact pads corresponding to the plurality of terminals 300. The contact pads may be electrically connected to one or more conductive traces in the first electrical component 800. The first electrical connector 100 is reliably fixed to the first electrical component 800 by applying pressure, such that the mounting tails 320 can reliably electrically connect with the contact pads. In some embodiments, the mounting tails of the terminals may be connected to contact pads on the first electrical component 800 based on technologies, such as surface mount technology (SMT) and/or through-hole technology (THT) to achieve electrical connection with the circuits of the first electrical component 800. In some embodiments, the mounting tails 320 each may be attached with a fusible element, such as a solder ball 600 (e.g., a tin ball), such that the mounting tails 320 are soldered to the contact pads on the first electrical component 800 in form of ball grid array (BGA). The mounting tails 320 can be electrically connected to the first electrical component 800 in any suitable manner, provided that the second electrical connector 100′ can be interconnected with the circuits on the first electrical component 800 through the first electrical connector 100. Exemplarily, the mounting tails 320 of the terminals 300 in each row may be aligned in the longitudinal direction X-X. Alternatively, any two adjacent mounting tails 320 in each row may respectively deviate from the row in opposite directions, thereby increasing the distance between adjacent mounting tails 320. This can increase the spacing between adjacent contact pads on the first electrical component 800, thereby further reducing the pitch of the terminals 300.

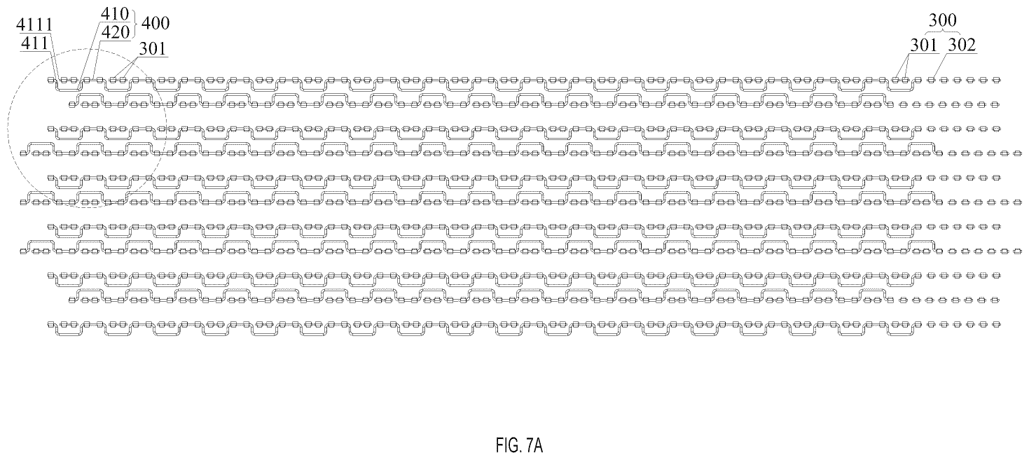

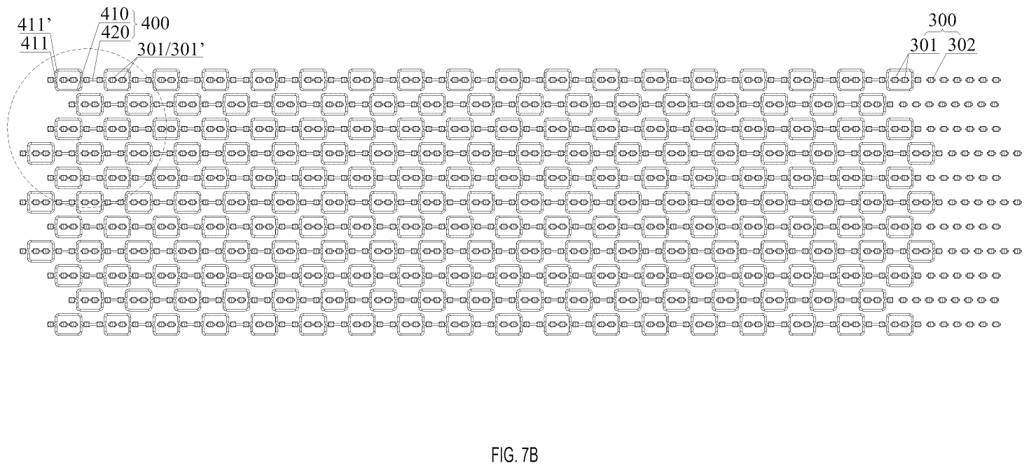

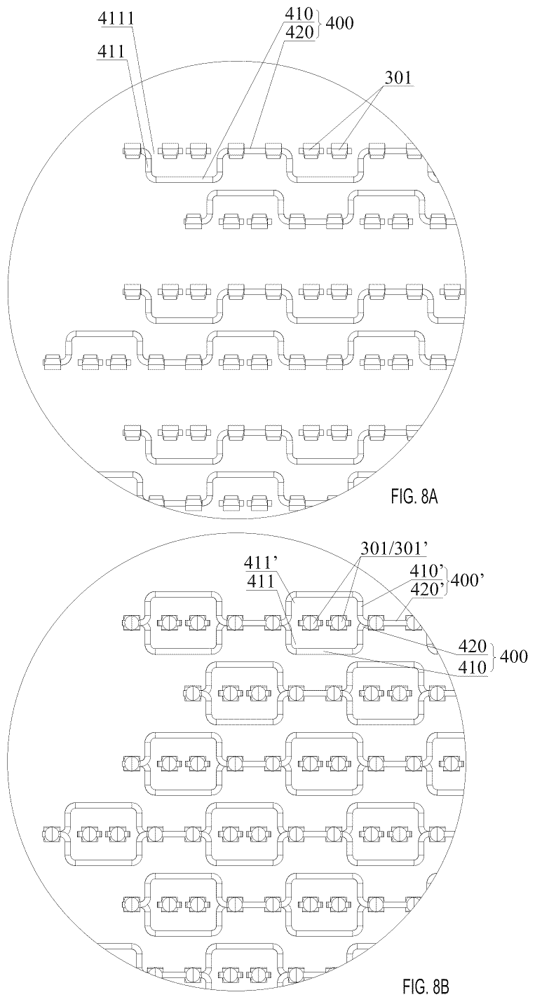

Exemplarily, the first portions 410 of the shield 400 each may be recessed along the transverse direction Y-Y to form recesses 411 corresponding to respective pairs of first terminals 301, as shown in FIGS. 6A to 6D. Each of the recesses 411 has an opening oriented in the same direction. The pairs of first terminals 301 may be at the openings 4111 of the recesses 411, respectively. The first terminals 301 each may be semi-enclosed by a respective first portion 410 of the shield 400, such that the first terminals 301 each can be shielded from three directions. FIG. 7A shows a top view of the terminals 300 and the shield 400 of the first electrical connector 100 according to an exemplary embodiment of the present disclosure, and FIG. 7B is a top view of the terminals 300 and the shield 400 of the first electrical connector 100 mating with terminals and a shield of the second electrical connector 100′. FIGS. 8A and 8B are partial enlargements of FIGS. 7A and 7B, respectively. With reference to FIGS. 7A to 7B and FIGS. 8A to 8B, the second electrical connector 100′ may include a plurality of pairs of first terminals 301′ for mating with the plurality of pairs of first terminals 301 of the first electrical connector 100 and a shield 400′ disposed on a side of the first terminals 301′. The shield 400′ may face to the openings 4111 of the recesses 411 along the transverse direction Y-Y, such that the mated first terminals 301′ and 301 are disposed between the shields 400 and 400′ for better shielding. Exemplarily, the shield 400′ may include a plurality of first portions 410′ corresponding to respective pairs of first terminals 301′ and a plurality of second portions 420′ each connecting adjacent first portions 410′. The first portions 410′ and the first portions 410 may shield the mated first terminals 301′ and 301 from four sides. Exemplarily, the first portions 410′ of the second electrical connector 100′ may comprise recesses 411′, and the openings of the recesses 411′ face the openings of the recesses 411 of the first electrical connector 100. The first portions 410 may abut against the first portions 410′ after the first electrical connector 100 is mated with the second electrical connector 100′, such that the first portions 410 and the first portions 410′ can enclose and shield the pairs of first terminals 301 respectively. The size of the recesses 411′ of the second electrical connector 100′ may be slightly larger than, slightly smaller than, or equal to that of the recesses 411 of the first electrical connector 100 in the longitudinal direction X-X and/or the transverse direction Y-Y. The recesses 411′ of the second electrical connector 100′ may not be completely center-to-center aligned with the recesses 411 of the first electrical connector 100 in the longitudinal direction X-X. Preferably, the recesses 411 and 411′ may be symmetrically disposed around the first terminals 301 and 301′, such that the first portions 410 and 410′ are uniformly distributed for better shielding effect. Moreover, the parasitic capacitance around the first terminals 301 can be more uniform by use of the enclosing shielding formed by the first portions 410 and 410′, avoiding the influence caused by the different dielectric constants of the housing assembly 200 and air. Thereby, signal integrity can be improved during signal transmission. It can simplify the design of the electrical connector and improve the reliability of the electrical connector by separating the enclosing shielding for any two pairs of mating first terminals 301′ and 301 into two portions on the first electrical connector 100 and the second electrical connector 100′ respectively.

To increase the signal transmission density of a single first electrical connector 100, multiple rows of the terminals may be provided to increase the terminals 300 within the limited size of the first mating interface 211 of the first electrical connector 100 without changing the pitch and the size of the terminals 300. As shown in FIG. 4A, exemplarily, the walls 2012 each may include a first side surface 213 and a second side surface 214 opposite along the transverse direction Y-Y. Taking the wall 2012b as an example, the rows of the terminals 300 may include a first row 351 disposed along the first side surface 213 and a second row 352 disposed along the second side surface 214. Thus, the walls 2012 can be reduced in number, and the thickness of the walls 2012 can be increased along the transverse direction Y-Y, such that the strength of the walls 2012 can be effectively improved to mount the shield 400 for the first row 351 and the second row 352.

As shown in FIG. 4B, for distinction, the shield 400 providing shielding for the first row 351 is referred to as a first shield 400a, and the shield 400 providing shielding for the second row 352 is referred to as a second shield 400b. The first portions 410 of the first shield 400a and the second shield 400b may be respectively embedded in the first side surface 213 and the second side surface 214 of the wall 2012b, and respectively spaced apart from the first terminals 301 in the corresponding rows. The first row 351 of the first terminals 301 and the second row 352 of the first terminals 301 may be respectively adjacent to the first side surface 213 and the second side surface 214. The recesses 411 formed by the first portions 410 of the first shield 400a and the second shield 400b are oriented in opposite directions, respectively. In the illustrated example, the recesses 411 of the first shield 400a are oriented in the same direction as the first side surface 213, and the recesses 411 of the second shield 400b are oriented in the same direction as the second side surface 214, such that two rows of the first terminals 301 may be located at the openings of the recesses 411 of the first shield 400a and the second shield 400b, respectively.

Still taking the wall 2012b as an example, after the first electrical connector 100 is mated with the second electrical connector 100′, the first shield 400a of the first electrical connector 100 may enclose the first terminals 301 along the first side surface 213 of the wall 2012a together with the shield 400′ of the second electrical connector 100′ which is inserted between the walls 2012a and 2012b. Similarly, the second shield 400b of the first electrical connector 100 may enclose the first terminals 301 along the second side surface 214 of the wall 2012a together with the shield 400′ of the second electrical connector 100′ which is inserted between the walls 2012b and 2012c. Thus, signal integrity performance can be improved after the first electrical connector 100 is mated with the first electrical connector 100′.

Exemplarily, the plurality of second portions 420 may be exposed outside the walls 2012, for example, may abut against the walls 2012. Exemplarily, the plurality of second portions 420 may be arranged in the rows of the terminals 300. Thereby, the second portions 420 may be interspersed among the pairs of the first terminals 301 in the rows, thereby providing shielding protection in the longitudinal direction X-X for the first terminals 301. Exemplarily, the shield 400′ of the second electrical connector 100′ may also have a similar structure. As shown in FIG. 8B, the second portions 420′ of the shield 400′ are arranged in the rows of the first terminals 301′. After the first electrical connector 100 is mated with the second electrical connector 100′, the second portions 420 of the shield 400 may be in electrical contact with the second portions 420′ of the shield 400′, such that the shields 400 and 400′ can be electrically connected to equal potential and provide a better shielding. In addition, the first portions 410 of the shield 400 and the first portions 410′ of the shield 400′ are generally inelastic because they are embedded in the walls. The first portions 410 and 410′ of the assembled electrical connectors may be spaced apart along the transverse direction Y-Y to form small gaps such that the second electrical connector 100′ can be easily and smoothly mated with the first electrical connector 100.

Moreover, such gaps are left on two sides of each pair of first terminals 301 along the longitudinal direction X-X. Accordingly, the shielding can be provided on the two sides of each pair of the first terminals 301 by the mated second portions 420 and 420′ arranged in the rows of the first terminals 301 and 301′. The second portions 420 and 420′ outside the walls may have elasticity. After the first electrical connector 100 is mated with the second electrical connector 100′, the second portions 420 and 420′ can exert certain normal pressures on each other, making their electrical contact reliable.

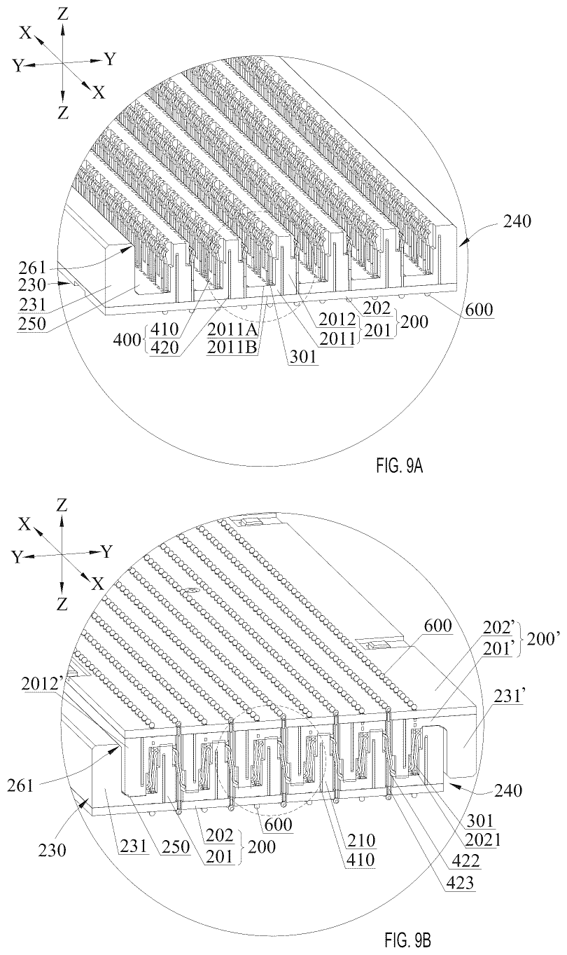

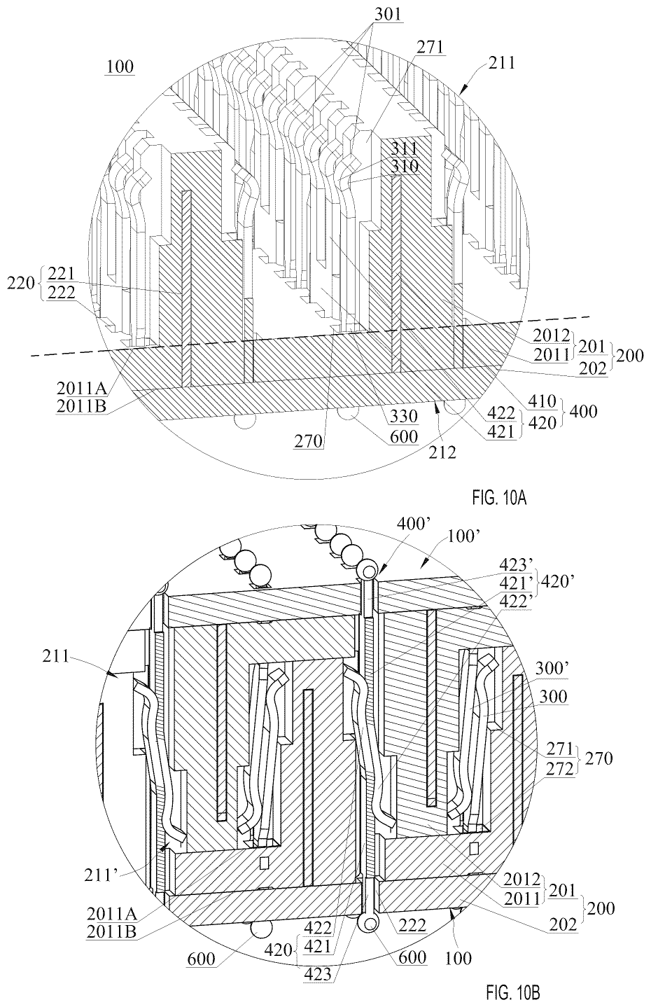

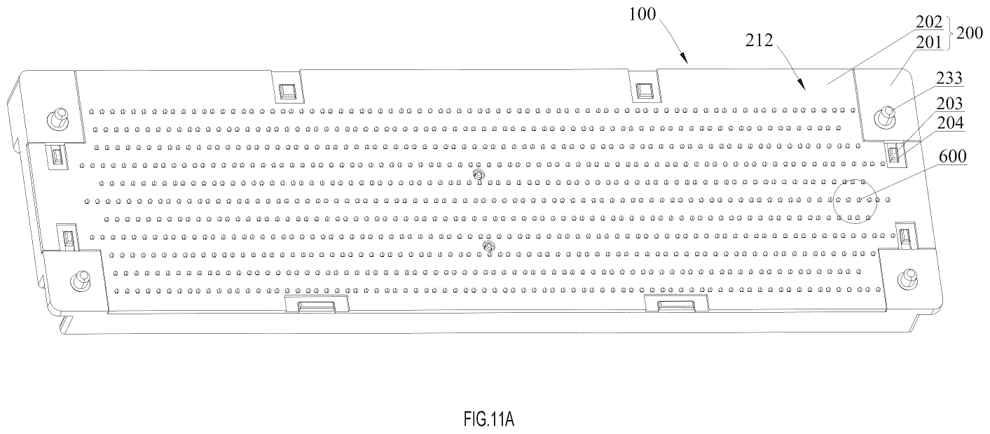

Exemplarily, as shown in FIGS. 9A and 10A, the housing assembly 200 may further include a base 2011, which may have a first surface 2011A (as indicated by a dashed line in FIG. 10A) and a second surface 2011B. Exemplarily, the first surface 2011A and the second surface 2011B may be opposite along the mating direction Z-Z. Where the first electrical connector 100 is a right-angle electrical connector, the first surface 2011A and the second surface 2011B may be perpendicular to each other. The walls 2012 may be connected to the first surface 2011A to form the first mating interface 211. The base 2011 and the walls 2012 may be a single piece formed by injection molding. This single piece may be referred to as an upper housing 201. Referring back to FIG. 4A, a plurality of walls 2012, such as 2012a, 2012b, 2012c, 2012d, 2012e, and 2012f, may be provided on the first surface 2011A of the base 2011. The plurality of walls 2012 are separated from each other along the transverse direction Y-Y to form gaps between adjacent walls 2012. Corresponding portions (e.g., walls 2012′ as shown in FIG. 2) of the second electrical connector 100′ may be inserted into these gaps. The walls 2012′ of the second electrical connector 100′ may be structurally the same as or similar to the walls 2012 of the first electrical connector 100. In this way, the first electrical connector 100 and the second electrical connector 100′ can be positioned to each other through the walls 2012 and 2012′ to achieve a reliable connection. As described above, each of the terminals 300 includes a mating contact portion 310 extending into the first mating interface 211 and a mounting tail 320 extending outside the second surface 2011B, as shown in FIG. 10A. In this way, portions of the terminals 300 may be embedded in the base 2011. As shown in FIGS. 6A to 6B, the intermediate portion 330 of each of the terminals 300 has barbs 332 on two sides thereof, and the intermediate portion 330 may be fixed in a respective terminal mounting channel 270 of the base 2011 by the barbs 332. In some embodiments, the base 2011 may also be over-molded onto the intermediate portions 330 of the terminals 300.

Exemplarily, as shown in FIGS. 6A to 6B, each of the second portions 420 of the shield 400 may include a connecting subportion 421 connected between two adjacent first portions 410. The connecting subportion 421 may be mounted into the base 2011. The first portions 410 each may extend from the base 2011 into a respective wall 2012. Exemplarily, with reference to FIGS. 4D and 10A, the connecting subportion 421 may extend beyond the first surface 2011A in a direction toward the first mating interface 211. The other part of the connecting subportion 421 may be embedded and fixed in the base 2011. Each of the second portions 420 may further include a beam 422, which may extend from the connecting subportion 421 to the first mating interface 211. The beam 422 may have a structure similar to or the same as that of a mating contact portion 310 of a terminal 300. The beam 422 may be bent outside a respective wall 2102. After the first electrical connector 100 is mated with the second electrical connector 100′, the beams 422 of the shield 400 may form an electrical connection with the shield 400′ of the second electrical connector 100′, such that the shield 400 of the first electrical connector 100 can be easily electrically connected to the shield 400′ of the second electrical connector 100′. The beams 422 can also form shielding for the first terminals 301 in the longitudinal direction, improving the signal integrity performance.

Although the plurality of walls 2012 are illustrated to be independent and spaced apart from each other, in some embodiments, the plurality of walls 2012 may be connected end to end to form a serpentine structure. The connecting subportions 421 may be partially embedded in the base 2011 in the illustrated embodiment, but in some embodiments, the connecting subportions 421 may be entirely disposed above the first surface 2011A or entirely embedded in the base 2011.

As described above, the pairs of first terminals 301 are arranged in rows parallel to the longitudinal direction, and the rows are spaced apart along the transverse direction Y-Y perpendicular to the longitudinal direction. For any two adjacent rows, exemplarily, one row is offset relative to the other row along the longitudinal direction, such that the pairs of first terminals 301 in one row are staggered from those in the other row. This can reduce crosstalk.

Exemplarily, for each of the second portions 420, the beam 422 may include a first beam portion 4221 and a second beam portion 4222 arranged in the rows of the terminals 300 along the longitudinal direction X-X. The first beam portion 4221 and the second beam portion 4222 may be evenly arranged between adjacent pairs of first terminals 301. Each of the first beam portion 4221 and the second beam portion 4222 may have a longitudinal dimension similar to that of the mating contact portions 310 of the first terminals 301. The first beam portion 4221 and the second beam portion 4222 may be bent outside the wall 2012 to be in electrical contact with corresponding portions of the shield 400′ of the second electrical connector 100′. Although each beam 422 has two beam portions 4221 and 4222 in the illustrated embodiment, optionally, each beam 422 may have only one beam portion or more beam portions. In each row, the spacing between adjacent pairs of first terminals 301 in a row may be wide enough to reduce crosstalk. Also, the first terminals 301 in the first row 351 and the second row 352 along a single wall 2012 may be completely staggered along the longitudinal direction X-X, so as to further reduce crosstalk. The number and size of the beam portions 422 in the spacing may be reasonably selected as needed. It may be desirable that the shielding structure around each pair of first terminals 301 is evenly spaced from the pair of first terminals 301. A wider beam portion or multiple beam portions may be considered to be disposed in the spacing between the first terminals 301. The contact resistance between the shields 400 and 400′ of the first electrical connector 100 and second electrical connector 100′ can be reduced, and the first electrical connector 100 can be mated with the second electrical connector 100′ reliably. The width of each beam portion can be reduced by disposing multiple beam portions in the spacing between every two adjacent first terminals 301. The beam portions each can have better elasticity to reduce resistance during the first electrical connector 100 being mated and unmated with the second electrical connector 100′.

Exemplarily, each of the second portions 420 may further include a shield mounting tail 423 extending from the connecting subportion 421 to outside the second surface 2011B, for connecting with a contact pad on the surface of the first electrical component 800. The contact pads of the shield mounting tails 423 of the second portions 420 may be electrically connected to shielding layers in the first electrical component 800 for providing a reference potential. The first electrical component 800 may also include routing layers having signal traces connected to the first terminals 301. Exemplarily, the shielding layers and the routing layers may be alternately arranged to provide shielding protection for the signal traces. Exemplarily, the shielding layers may be grounded. The second portions 420 may be connected to a shielding layer for grounding, which can improve signal integrity performance. In addition, the shield mounting tails 423 may also mechanically connect the shield 400 to the first electrical component 800 to fix the first electrical connector 100 such that it is uneasy to loosen during the plugging and unplugging of the second electrical connector 100′. Exemplarily, the shield mounting tails 423 may have the same or similar structure as the mounting tails 320 of the terminals 300, so that the shield mounting tails 423 are connected to the contact pads on the surface of the first electrical component 800 in the same manner. In the illustrated embodiment, each of the shield mounting tails 423 and the mounting tails 320 is attached with a solder ball 600. Optionally, the second portions 420 each may have shield mounting tails 423 in one-to-one correspondence with the beams 422 to provide uniform impedance. The beams 422 and shield mounting tails 423 have extension lengths that are approximately the same as those of the mating contact portions 310 and the mounting tails 320 of the first terminals 301, so that the second portions 420 can provide better shielding along the length of the first terminals 301.

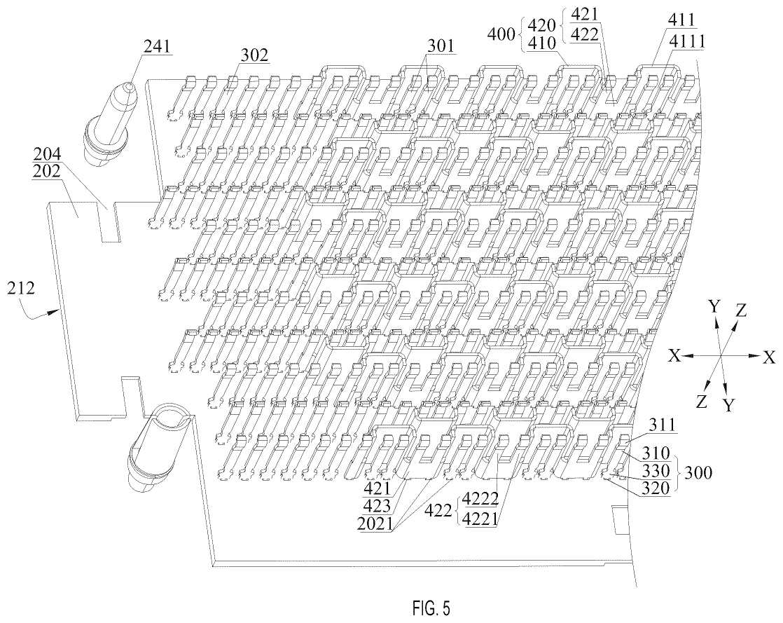

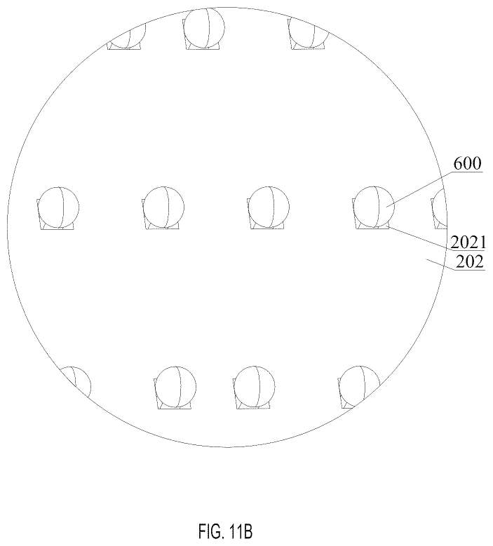

It is appreciated that, to improve the strength of the upper housing 201 and reduce the probability of accidental contact between the terminals 300 and the shield 400 during the first electrical connector 100 being mated with the second electrical connector 100′, the first portions 410 of the shield 400 (especially the portions corresponding to the mating contact portions 310 of the first terminals 301) may be completely covered by the walls 2012 of the upper housing 201, and each of the second portions 420 may be partially exposed in the first mating interface 211. In this case, the shield 400 generally cannot be mounted into the upper housing 201 from the first mating interface 211. Instead, the shield 400 may be mounted into the upper housing 201 from the first mounting interface 212, and that is, the shield 400 is inserted into the upper housing 201 from the second surface 2011B. During soldering of the first electrical connector 100 to the first electrical component 800, it is necessary to avoid solder from adhering to exposed portions of the shield 400, which may cause accidental short circuits between the first terminals 301 and the shield 400. Exemplarily, the housing assembly 200 may further include a lower housing 202, which may be attached to the second surface 2011B of the upper housing 201 and form the first mounting interface 212 of the housing. The lower housing 202 may comprise a plurality of through-holes 2021, as shown in FIG. 5 and FIGS. 11A and 11B. FIG. 5 shows the lower housing 202 from above, in which the upper housing 201 is hidden to show the terminals 300 and the shield 400. FIGS. 11A and 11B show the lower housing 202 from below. The mounting tails 320 of the terminals 300 and the shield mounting tails 423 of the shield 400 pass through the plurality of through-holes 2021 respectively. In the embodiment shown in the figures, the through-holes 2021 may be slightly larger than the mounting tails 320 and the shield mounting tails 423, so that the lower housing 202 can be easily mounted to the upper housing 201.

A solder ball 600 may be attached to each of the mounting tails 320 of the terminals 300 and the shield mounting tails 423 of the shield 400. The solder ball 600 may be a small ball made of solder tin. The solder balls 600 may be correspondingly placed on the mounting tails 320 and the shield mounting tails 423 and heated to connect to the mounting tails 320 and the shield mounting tails 423. A screen may be used during the process of placing the solder balls 600. Exemplarily, the mounting tails 320 of the terminals 300 and the shield mounting tails 423 of the shield 400 may respectively extend into the through-holes 2021 through the second surface 2011B of the base 2011, but hardly protrude outside the through-holes 2021. Thus, at least a portion of each of the solder balls 600 may be received in a respective through-hole 2021. Thus, the screen can be omitted. Thereby, the costs can be saved, and the process can be simplified. During the process of heating the solder balls 600 to wet the mounting tails 320 and the shield mounting tails 423, the through-holes 2021 of the lower housing 202 can prevent the solder balls 600 from being wetted too much along the mounting tails 320 and the shield mounting tails 423. The first electrical connector 100 can be sufficiently soldered to the first electrical component 800. In some embodiments, the through-holes 2021 may be tapered holes. Small-dimension ends of the tapered holes may face the second surface 2011B of the base 2011, and large-dimension ends of the tapered holes may face the solder balls 600. The large-dimension ends may position the solder balls 600, and the through-holes 2021 may become slender toward the second surface 2011B of the base 2011, preventing the solder balls 600 from wetting excessively after melting. In some embodiments, the solder balls 600 may be attached to the mounting tails 320 and the shield mounting tails 423 by solder paste, such as tin paste.

Continuing to refer to FIG. 11A, in some embodiments, the lower housing 202 may be joined to the upper housing 201 by hot riveting, for instance, at edge areas of the lower housing 202. In the illustrated embodiment, there are eight riveting points between the lower housing 202 and the upper housing 201. In some embodiments, there may be more or fewer riveting points. Exemplarily, the upper housing 201 may comprise riveting protrusions 203, and the lower housing 202 may comprise riveting openings 204 (see FIGS. 5 and 11A). After the upper housing 201 and the lower housing 202 are assembled, the riveting protrusions 203 may be inserted into the riveting openings 204. Then, the riveting protrusions 203 formed of thermoplastic material may be locally heated to hot-rivet the lower housing 202 to the upper housing 201. The lower housing 202 may be made of a material with a melting point higher than that of the upper housing 201, such that the lower housing 202 can be hardly influenced during the connection of the solder balls 600 to both the mounting tails 320 of the terminals 300 and the shield mounting tails 423 of the shield 400.

As described above, the shield 400 is inserted into the upper housing 201 from the second surface 2011B. After the lower housing 202 is fixed to the upper housing 201, the shield 400 may also be clamped between the upper housing 201 and the lower housing 202. The plurality of terminals 300 may also be inserted into the upper housing 201 from the second surface 2011B. In this way, the shield 400 and the terminals 300 can be firmly fixed by the upper housing 201 and the lower housing 202. Thus, the first portions 410 of the shield 400 are covered. The shield 400 and the terminals 300 are reliably fixed in the connector.

Exemplarily, the housing assembly 200 may comprise a plurality of terminal mounting channels 270. The plurality of terminals 300 are respectively mounted into the plurality of terminal mounting channels 270. The terminals 300 and the shield 400 are hidden in FIG. 4C relative to FIG. 4B. Referring to FIGS. 4A to 4E, the plurality of terminal mounting channels 270 may extend from the second surface 2011B of the base 2011 of the upper housing 201 into the walls 2012 to form grooves 271 in the walls 2012, such as those in the wall 2012a in FIG. 4D. The grooves 271 may serve as portions of the terminal mounting channels 270 for positioning the terminals 300 in the terminal mounting channels 270. The intermediate portions 330 of the terminals 300 may be embedded in the portions of the terminal mounting channels 270 inside the base 2011. The mating contact portions 310 of the terminals 300 may bend outside the walls 2012 from the grooves 271, such as the terminals 300 in the wall 2012b in FIG. 4D. It is simpler to assemble the terminals 300 into the upper housing 201 than over-molding of the upper housing 201 onto the terminals 300. Moreover, the yield can be improved and the costs can be further reduced by injection-molding the upper housing 201.

Exemplarily, the upper housing 201 may further comprise a shield mounting channel 220, as shown in FIGS. 4C-4E and 10A. As described above, the shield 400 may be mounted to the shield mounting channel 220 from the bottom surface of the upper housing 201, i.e., the second surface 2011B of the base 2011. The shield mounting channel 220 may include a plurality of first channel portions 221. Each of the plurality of first channel portions 221 extends from the base 2011 into a respective wall 2012 along the mating direction Z-Z. The plurality of first portions 410 of the shield 400 may be respectively mounted into the plurality of first channel portions 221. The plurality of first channel portions 221 have U-shaped cross sections, which correspond to the recesses 411 of the first portions 410 of the shield 400. The first channel portions 221 may pass through the base 2011 along the mating direction Z-Z and extend inside the walls 2012 to accommodate the first portions 410 of the shield 400. In other words, the first channel portions 221 each may be disposed in both the base 2011 and a respective wall 2012.

The shield mounting channel 220 may further include a plurality of second channel portions 222, which may be inside the base 2011. The plurality of second channel portions 222 each may be connected between two adjacent first channel portions 221, so that the plurality of second portions 420 of the shield 400 are respectively mounted into the plurality of second channel portions 222.

After the second portions 420 are mounted into the second channel portions 222, the second portions 420 may protrude from the first surface 2011A and be exposed in the first mating interface 211. Exemplarily, the beams 422 of the second portions 420 may protrude to the first surface 2011A and extend into the first mating interface 211 to be in electrical contact with the shield 400′ of the second electrical connector 100′, as shown in FIG. 10B. Exemplarily, the first mating interface 211 of the first electrical connector 100 and the second mating interface 211′ of the second electrical connector 100′ may have the same or similar structures, such that the terminals 300′ and the shield 400′ of the second electrical connector 100′ may be the same as or similar to the terminals 300 and the shield 400 of the first electrical connector 100 in structure. The second portions 420′ of the shield 400′ each may include a connecting subportion 421′ and a beam 422′. Exemplarily, the connecting subportions 421 of the second portions 420 of the shield 400 may protrude from the first surface 2011A and extend into the first mating interface 211, the beams 422 of the second portions 420 may be in electrical contact with the connecting subportions 421′ of the shield 400′ respectively, and the beams 422′ of the shield 400′ may be in electrical contact with the connecting subportions 421 of the shield 400 respectively. The second portions 420 each may be electrically connected with a respective second portion 420′ at multiple points on the connecting subportion 421 and 421′. Thus, the shields 400 and 400′ can be reliably electrically connected. Similarly, multiple electrical contact points are formed for each pair of the terminals 300 and 300′.

Exemplarily, both the shield mounting channel 220 and the terminal mounting channels 270 extend to the second surface 2011B of the base 2011. The shield 400 may be mounted into the shield mounting channel 220 from the second surface 2011B of the base 2011 of the upper housing 201. Similarly, the terminals 300 may also be mounted into the terminal mounting channels 270 from the second surface 2011B of the base 2011. As described above, the surfaces of the walls 2012 may be provided with the grooves 271. As shown in FIGS. 4D and 10B, the terminal mounting channels 270 may include the grooves 271 and the openings 272 penetrating the base 2011, for mounting the terminals 300.

In the case where the housing assembly 200 includes a plurality of walls 2012, such as 2012a to 2012f, spaced apart along the transverse direction Y-Y, at least a side of each wall 2012 may be provided with a row of terminals 300, and each row of terminals 300 may have a respective shield 400. The rows of terminals 300 and the shields 400 may be symmetrical with respect to a symmetry axis parallel to the longitudinal direction X-X. This allows the second mating interface 211′ of the second electrical connector 100′ (including the terminals 300′ and the shield 400′ in the second mating interface 211′ ) to have the same or similar structure as the first mating interface 211 of the first electrical connector 100 (including the terminals 300 and the shield 400 in the first mating interface 211). Thus, the molds for molding the housing assembly 200 can be simplified in structure, and costs can be reduced. The first electrical connector 100 and the second electrical connector 100′ are possible to be the same in structure by the symmetrical arrangement of the rows of terminals 300 and the shields 400.

Exemplarily, the plurality of walls 2012 may be arranged at equal intervals along the transverse direction Y-Y. Two rows of terminals 300 are respectively disposed along adjacent walls 2012 within a first spacing between the adjacent walls 2012. Each row of terminals 300 has a shield 400 mounted to the corresponding wall 2012. As described above, the terminals 300 each includes a mating contact portion 310 extending to the first mating interface 211 of the housing assembly 200 and a mounting tail 320 extending to the first mounting interface 212 of the housing assembly 200. The mating contact portion 310 bends outside the corresponding wall 2012 at the first mating interface 211. Optionally, the mating contact portion 310 may include a straight segment connected to the intermediate portion 330, which may be completely embedded in the wall 2012 or slightly protrude from the wall 2012. In the case where the straight segment of the mating contact portion 310 slightly protrudes from the wall 2012, a second spacing between the two rows of terminals 300 along the adjacent walls 2012 is smaller than the first spacing between the adjacent walls 2012. The second spacing between two rows of terminals 300 is configured to receive a wall of a second electrical connector 100′ with the same structure as the wall 2012 and two rows of terminals on both sides of the wall of the second electrical connector 100′, such that a wall and two rows of terminals on two sides of the wall of the second electrical connector 100′ can be inserted into this spacing. The second electrical connector 100′ at least has the same mating interface as the first electrical connector 100.

The first electrical connector 100 generally has the same structure as the second electrical connector 100′ in the illustrated embodiment. Optionally, the first electrical connector 100 and the second electrical connector 100′ may be the same only at the mating interfaces, including the terminals and shields.

Exemplarily, the rows of the terminals may be odd, such that only one wall on an edge has a row of terminals on one side, and other walls each has two rows of terminals on both sides. Thereby, the space utilization in the first electrical connector 100 can be improved. At least of the mating interface of the second electrical connector 100′ may have the same structure as that of the first electrical connector 100.

Exemplarily, the housing assembly 200 may have a first edge 230 and a second edge 240 opposite along the transverse direction Y-Y, as shown in FIG. 4A. The first edge 230 and the second edge 240 have complementary structures, such that at least the mating interfaces of the first electrical connector 100 and the second electrical connector 100′ are substantially structurally identical. When the first electrical connector 100 is mated with the second electrical connector 100′, the first edge 230 of the first electrical connector 100 may be mated with the second edge 240′ (having the same structure as the second edge 240) of the second electrical connector 100′, and the second edge 240 of the first electrical connector 100 may be mated with the first edge 230′ (having the same structure as the first edge 230) of the second electrical connector 100′. In this case, there is no need to prepare two types of different electrical connector 100 and 100′, and only one type of electrical connector may be provided to achieve the interconnection. Thus, manufacturing costs and difficulties can be reduced.

Referring back to FIGS. 3 and 4A, exemplarily, the first edge 230 includes a rib 231 extending along the longitudinal direction. The walls 2012f to 2012a are arranged from a position adjacent to the rib 231 to the second edge 240. The wall 2012f adjacent to the rib 231 and the rib 231 enclose a positioning slot 250, and the wall 2012a on the second edge 240 matches with the positioning slot 250. Thus, when the first electrical connector 100 is mated with a second electrical connector 100′ at least having a mating interface which is identical to that of the first electrical connector 100, a positioning slot of one electrical connector is engaged with a wall on the second edge of other electrical connector. Since the walls 2012 need to comprise the shield mounting channels 220 for the shields 400, the mechanical strength of the walls 2012 may be slightly lower than that of the rib 231. The wall 2012f adjacent to the rib 231 has terminals 300 and shields 400 on both sides, and the rib 231 can protect the wall 2012f. The wall 2012a on the second edge 240 may be provided with terminals 300 and a shield 400 only on the side facing the adjacent wall 2012b. The wall 2012a may have a thickness similar to that of other walls 2012b to 1012f, without affecting the mechanical strength of the wall 2012a. Except for the wall 2012a, other walls 2012b to 1012f may have terminals 300 and shields 400 on both sides. To improve the mechanical strength of the walls 2012b to 1012f and increase the spacing between two rows of the first terminals 301 in each of the walls 2012b to 1012f, the pairs of the first terminals 301 along each of the walls 2012b to 1012f are staggered in the longitudinal direction X-X.

When the first electrical connector 100 is mated with the second electrical connector 100′, the rib 231 can protect the wall 2012f from the outside, such that the first electrical connectors 100 can be improved in mechanical strength and uneasily damaged by external vibrations. For optimal signal integrity (SI) performance and/or reliable power supply, the terminals 300 of the first electrical connector 100 should be aligned with and in contact with the terminals 300′ of the second electrical connector 100′, which may have a mating interface identical to that of the first electrical connector 100. In some embodiments, the rib 231 forming the positioning slot 250 may be provided with a first chamfer 261 and the wall 2012a on the second edge 240 may be provided with a second chamfer 262. These chamfers are designed to guide the second electrical connector 100′ during mating with the first electrical connector 100. The positioning slot 250 and the wall 2012a on the second edge 240 provide guiding and positioning for the second connector 100′, thereby enabling the terminals 300 of the first electrical connector 100 to reliably contact with the terminals 300′ of the second connector 100′.

For the first mating interface 211 of the first electrical connector 100, an imaginary line passing through the middlemost row of terminals is defined (see the dashed line in FIG. 4A). The upper and lower parts divided by the dashed line in FIG. 4A are structurally complementary, such that another first electrical connector, when rotated 180 degrees in an X-Y plane from its orientation in FIG. 4A, can mate with the original first electrical connector 100. Thus, at least the first mating interface of the second electrical connector 100′ can be manufactured to have the same structure as that of the first electrical connector 100. The mating contact portions 310 of any two rows of terminals 300 symmetrical with respect to the dashed line face a first direction. Referring to FIGS. 9A-9B, the second electrical connector 100′ identical to the first electrical connector 100 is rotated and mated with the first electrical connector 100, such that the mating contact portions of the second electrical connector 100′ that originally face a first direction now face a opposite second direction and contact with mating contact portions of the first electrical connector 100 facing the first direction, respectively. The terminals 300 each may include a deformable portion and a non-deformable portion. The deformable portion may elastically deform under external force and abut against the object which put the force. The non-deformable portion is fixed in the housing assembly 200. Ends of the terminals 300 may be more prone to deformation due to longer lever arms. After the first electrical connector 100 is mated with the second electrical connector 100′, the deformable portions of the terminals 300 abut against the non-deformable portions of the second electrical connector 100′. Conversely, the deformable portions of the second electrical connector 100′ abut against the non-deformable portions of the first electrical connector 100. It enables the reduction of terminal lengths in both connectors, thereby minimizing signal oscillation.

The first portions 410 of each shield 400 are designed to correspond to the first terminals 301 in a respective row of terminals 300. The second portions 420 of the shield 400 may contact the second portions 420′ of the second electrical connector 100′ in a similar manner to the terminals. In the case where the second portions 420 of shield 400 have beams 422 shaped as the terminals 300, the beams 422 of the first connector 100 can contact beams 422′ of the second connector 100′, similar to terminals of the two connectors. In this way, ground reliability can be enhanced and ground resistance can be reduced.

As described above, the first electrical connector 100 can mate with the identical second electrical connector 100′ through the wall on the second edge of the second electrical connector 100′ inserted into the positioning slot 250 on the first edge 230 of the first electrical connector 100, and the wall 2012a on the second edge 240 of the first electrical connector 100 inserted into the positioning slot on the first edge of the second electrical connector 100′. To minimize the first electrical connector 100, the first chamfer 261 of the rib 231 and the second chamfer 262 of the wall 2012a must have limited dimensions. This dimensional constraint reduces their alignment guidance efficiency, requiring the first electrical connector 100 and the second electrical connector 100′ to be pre-aligned before effective mating can occur. Exemplarily, the first edge 230 may include a positioning post 232 at a corner of the housing assembly 200, as shown in FIGS. 3-4A. Exemplarily, the positioning post 232 may be connected between the rib 231 and the wall 2012f around the positioning slot 250. The positioning post 232 may comprise a positioning hole 2321. The second edge 240 may include a positioning pin 241, which can be inserted into the positioning hole 2321. When the first electrical connector 100 is mated with the identical second electrical connector 100′, the positioning pin 241 of the first electrical connector 100 is inserted into a positioning hole of the second electrical connector 100′, and the positioning hole 2321 of the first electrical connector 100 receives a positioning pin of the second electrical connector 100′. The positioning pin 241 and the positioning hole 2321 can provide coarse alignment for the electrical connectors. Once the positioning pin 241 is inserted into the positioning hole 2321, the positioning slot 250 and wall 2012a take over to achieve alignment between the two connectors. For example, the positioning pin 241 may feature a conical tip and a shaft. During insertion into the positioning hole of the second connector 100′, the conical tip provides radial alignment by guiding the first electrical connector 100 to mate with the second electrical connector 100′. Subsequently, the shaft facilitates precise positioning, enabling the two connectors to achieve flush engagement. Even if external forces induce misalignment during mating of the first electrical connector 100 with the second electrical connector 100′, the resultant displacement or angular deviation may not exceed the insertion tolerance of the positioning pin 241 into the positioning hole 2321. Thus, the second electrical connector 100′ can be more easily mated with the first electrical connector 100.

Exemplarily, a head of the positioning post 232 may be provided with a third chamfer 263. The positioning pin 241 may be located in a recess 242 formed between the walls 2012a and 2012b. When the positioning pin 241 is inserted into the positioning hole 2321 of the positioning post 232, the positioning post 232 can be inserted into the recess 242, such that the second electrical connector 100′ can be easier to align with the first electrical connector 100. Exemplarily, the third chamfer 263 on the positioning post 232 is designed to provide guiding functionality, thereby enabling alignment during mating.

Exemplarily, the positioning pin 241 may be configured as a first power terminal. The positioning post 232 may be connected with a second power terminal (pin) 233 extending outside the first mounting interface 212 of the housing assembly 200, as shown in FIG. 11A. When the first electrical connector 100 is connected to the first electrical component 800, the second power terminal 233 can be electrically connected to the first electrical component 800. When the first electrical connector 100 is mated with the identical second electrical connector 100′, the positioning pin can be electrically connected to the second power terminal by being inserted into the positioning hole on another electrical connector. Exemplarily, the first electrical component 800 may be a main board, and the second electrical component 900 mounted with the second electrical connector 100′ may obtain power from the main board. In this way, an electronic system with such electrical connectors of the present disclosure can simplified structurally. The positioning pin 241, which doubles as the first power terminal, may have a conical end to facilitate reliable contact with the second power terminal 233 electrically connected to the positioning post 232. The conical end can also guide the mating of the first electrical connector 100 with the second electrical connector 100′. This dual-function design provides both mechanical alignment and electrical conductivity in a single structure. The second power terminal 233 and the positioning pin 241 can be designed to carry a large rated current. In some embodiments, the mated second power terminal and positioning pin are capable of carrying a current of up to 5 A, which is sufficient to power the electronic components on the second electrical component 900. In alternative embodiments, the rated current of the second power terminal 233 and positioning pin 241 can be scaled up or down to deliver the required amperage. Optionally, the second electrical component 900 can supply power to the first electrical component 800 through the second power terminal 233 and the positioning pin 241. To enable the first electrical component 800 to carry sufficient current, the second power terminal 233 is configured as a pin-through-hole terminal connected to one or more power layers inside the first electrical component 800. The power layers within the first electrical component 800 are electrically connected to the second power terminal 233, to share the current load to enhance conductivity. Additionally, the second power terminal 233 inserted into a hole in the first electrical component 800 also provides lateral positioning for the first electrical connector 100. This design eliminates the need for additional positioning features or reduces their quantity.

The first electrical connector 100 can provide a transmission data rate of up to 224 G, supporting up to 216 or 199 differential pairs and 70 power terminals. Additionally, it provides 4 power terminals with a maximum of 5A to supply power to components requiring high current.

Exemplarily, as shown in FIG. 4A, the plurality of terminals 300 may further include a plurality of second terminals 302. The plurality of second terminals 302 may be arranged in rows, with no shield 400 disposed on the sides of the second terminals 302. The second terminals 302 may be configured to transmit low-current power signals and/or low-speed signals. According to some embodiments, the second terminals 302 may include sideband terminals, which can transmit low-frequency signals (e.g., with a frequency below 500 MHz) and lower-data-rate signals (e.g., below 100 Mb/s). According to some embodiments, the second terminals 302 may also include power terminals, which can transmit direct current. Additionally or alternatively, the power terminals can transmit other high-current and low-frequency signals. As explained, the second portions 420 and/or beams 422 on the second portions 420 of the shield 400 would occupy a portion of terminal mounting channels, reducing the number of terminals available for power or low-speed signal transmission. By contrast, the absence of shields on the sides of second terminals 302 enhances the density of effective signal-transmitting terminals 300. During production of the first electrical connector 100, the arrangement of the shield 400 may be appropriately adjusted as needed. The housing assembly 200 also needs to be appropriately adjusted if the terminal mounting channels in the housing assembly 200 are not uniform. As illustrated, the second terminals 302 may be disposed at an end portion of the first electrical connector 100 along the longitudinal direction Y-Y, while the first terminals 301 and the shield 400 are disposed at the other end portion, with a clear boundary between them. In some embodiments, the first terminals 301 and the shield 400 may be disposed in the middle portion of the first electrical connector 100 along the longitudinal direction, with the second terminals 302 disposed at two ends portions. Alternatively, the second terminals 302 may be disposed in the middle portion along the longitudinal direction, and the first terminals 301 and the shield 400 may be disposed at two ends portions. In this case, the shield 400 of each row is divided into two segments by the second terminals 302. In some embodiments, the first terminals 301 and the shield 400 may be disposed on a first side of the first electrical connector 100, and the second terminals 302 on the second side opposed to the first side along the transverse direction Y-Y.

According to aspects of the present disclosure, an electronic system is provided, which may include a first electrical connector 100 and a mated second electrical connector 100′. The first electrical connector 100 may include a plurality of pairs of terminals, such as the pairs of first terminals 301. The second electrical connector 100′ may include a plurality of pairs of terminals, such as the pairs of first terminals 301′. The pairs of first terminals 301 are arranged in rows parallel to the longitudinal direction Y-Y, and the pairs of first terminals 301′ are arranged in rows parallel to the longitudinal direction Y-Y. The first electrical connector 100 and the second electrical connector 100′ further include shields 400 and 400′, respectively, disposed alongside the rows of the terminals correspondingly. The shields are designed to block external electromagnetic interference (EMI) from coupling into signal terminals and to suppress electromagnetic radiation from signal terminals 300. The shield 400 may include a plurality of first portions 410 provided corresponding to the pairs of first terminals 301 and a plurality of second portions 420 each connected between adjacent first portions 410. The shield 400′ may include a plurality of first portions 410′ provided corresponding to the pairs of first terminals 301′ and a plurality of second portions 420′ each connected between adjacent first portions 410′. When the first electrical connector 100 is mated with the second electrical connector 100′, the first terminals 301 of the first electrical connector 100 establish electrical contact with the first terminals 301′ of the second electrical connector 100′, while the second portions 420 of the shield 400 of the first electrical connector 100 establish electrical contact with the second portions 420′ of the shield 400′ of the second electrical connector 100′, so as to achieve a common ground between the first electrical component 800 mounted with the first electrical connector 100 and the second electrical component 900 mounted with the second electrical connector 100′, ensuring reliable signal transmission with reduced electromagnetic interference (EMI). For any two pairs each including a first terminal 301 and a first terminal 301′ in electrical contact, the first portions 410 and 410′ of two shields 400 and 400′ form an enclosing shield. The enclosing shield can provide optimal shielding protection against interference signals of various frequency bands, ensuring optimal signal integrity during high-speed signal transmission.

Exemplarily, for the first electrical connector 100, the first terminals 301 each includes a mating contact portion 310 and a mounting tail 320 opposite along its length direction, and the first portions 410 of the shield 400 extend from the first mounting interface 212 at least to the mating contact portions 310 of respective pairs of first terminals 301. The second electrical connector 100′ employs a mirroring structure. In this way, the first terminals of the two connectors are only exposed in the mating direction. Consequently, EMI penetration is reduced by the enclosing shield formed by the first portions of the two shields 400 and 400′. The shielding protection can be improved and the connectors are simplified structurally.

Exemplarily, for each of the first and second electrical connectors, each of first portions of a shield is recessed along the transverse direction Y-Y to form a recess, such that the openings of the recesses of the first and second electrical connectors face each other when the two connectors are mated. The recesses 411 can be formed by stamping the shield 400, whereby the shield 400 can be an integrated and simple member with lower production costs.

According to aspects of the present disclosure, an electronic system is provided, including mating first and second electrical connectors that are identical at least at their mating interfaces. This design reduces part types, lowering management costs and complexities. Additionally, the first and second electrical connectors may also be identical at the mounting interface. Exemplarily, the first and second electrical connectors may have different heights. In an exemplary embodiment, the electrical connectors may be standard components of varying sizes, for instance, some connectors may have a height of approximately 2.5 mm in the mating direction Z-Z, and some connectors may have a height of approximately 5 mm in the mating direction. There may be some other types of connectors connected between the first electrical component 800 and the second electrical component 900. Suitable electrical connectors of the present disclosure can be selected to achieve compatibility with other connector, such that the electrical connectors of the present disclosure can be widely used in more systems. Optionally, the mating first and second electrical connectors may also have the same height.

According to aspects of the present disclosure, a method for manufacturing an electrical connector is provided. The method may include inserting a plurality of terminals arranged in a row parallel to the longitudinal direction and a shield into an upper housing from a bottom of the upper housing along the mating direction; attaching a lower housing to the bottom of the upper housing; securing the lower housing to the upper housing by hot riveting.

In this configuration, the lower housing and the upper housing can securely clamp the terminals and the shield, preventing the terminals and the shield from falling off. The lower housing also fully encloses the terminals and the shield to prevent foreign objects ingress. Hot riveting, employed at the interface between the housings, may enable high connecting strength through a relatively simple process.

Exemplarily, the lower housing may comprise a plurality of through-holes. Mounting tails of the plurality of terminals and the shield are inserted into the plurality of through-holes, respectively. The method may further include attaching a plurality of solder balls to the plurality of mounting tails, with at least a portion of each of the solder balls seated in a respective through-hole. This allows solder balls to be easily distributed to respective mounting tails without a screen. For example, the step may include pouring the solder balls onto the lower housing of the electrical connector, spreading the solder balls evenly to embed into respective through-holes, and cleaning off redundant solder balls. This approach may eliminate screen costs and streamlines the process.

Exemplarily, the upper housing may include a base having a first surface and a second surface opposite along the mating direction. The upper housing further includes walls attached to the first surface and elongated in longitudinal direction. The walls and the first surface collectively form a mating interface through which the first electrical connector 100 is mated with the second electrical connector 100′. The plurality of terminals each has a mating contact portion protruding into the mating interface. The terminals each has a portion inserted into the base and a respective wall. Also, the shield is inserted into the base and extends into the mating interface.

Exemplarily, the upper housing includes a plurality of terminal mounting channels extending from the second surface, through the base, and into the walls. The terminals are inserted into the terminal mounting channels. The terminal mounting channels open into the mating interface, allowing the terminals to protrude into the mating interface.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Various changes can be made to the structures illustrated and described herein. For example, the electrical connectors described above can be any suitable connectors, such as card edge connectors, backplane connectors, daughter card connectors, stacking connectors, mezzanine connectors, I/O connectors, chip sockets, Gen Z connectors, etc.

Although many innovative aspects are described above with reference to vertical connectors, it should be understood that the aspects of the present disclosure are not limited thereto. As such, any of the innovative features, alone or in combination with one or more other innovative features, can also be applied to other types of connectors, such as right-angle connectors and coplanar connectors.

In the description of the present disclosure, it is to be understood that orientation or positional relationships indicated by orientation words “front”, “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a wall elongated in a longitudinal direction;
a plurality of terminals each comprising a mating contact portion, a tail, and an intermediate portion between the mating contact portion and the tail, the mating contact portions of the plurality of terminals disposed along the wall; and
a shield comprising:
a plurality of first portions each comprising a recess such that one or more terminals of the plurality of terminals are disposed therein, and
a plurality of second portions aligned with the plurality of terminals, each of the plurality of second portions connecting adjacent first portions of the plurality of first portions.

2. The electrical connector of claim 1, wherein:
the plurality of first portions are at least partially embedded in the wall of the housing.

3. The electrical connector of claim 1, wherein each of the plurality of second portions comprises:
a subportion connecting the adjacent first portions, and
one or more beams extending from the subportion, the one or more beams aligned with the mating contact portions of the plurality of terminals.

4. The electrical connector of claim 3, wherein:
each of the plurality of second portions comprises one or more tails aligned with the tails of the plurality of terminals.

5. The electrical connector of claim 4, wherein:
the housing comprises a base;
the wall protrudes from the wall;
the plurality of second portions of the shield are fixedly held by the base of the housing; and
the tails of the plurality of second portions of the shield extend beyond the base of the housing.

6. The electrical connector of claim 1, wherein:
the plurality of terminals are a plurality of pairs of first terminals disposed in the recesses of respective first portions of the plurality of first portions of the shield; and
the electrical connector comprises one or more second terminals aligned with the plurality of terminals in the longitudinal direction and unshielded by the shield.

7. The electrical connector of claim 1, wherein:
the housing is an upper housing; and
the electrical connector comprises a lower housing comprising a plurality of through-holes into which the tails of the plurality of terminals and the tails of the shield extend.

8. The electrical connector of claim 7, comprising:
a plurality of solder balls each attached to the tail of the shield or a respective terminal, wherein each of the plurality of solder balls is at least partially received in a respective through-hole of the plurality of through-holes of the lower housing.

9. An electrical connector comprising:
a plurality of terminals each comprising a mating contact portion, a tail, and an intermediate portion between the mating contact portion and the tail, the plurality of terminals comprising a first plurality of terminals disposed in a first row and a second plurality of terminals disposed in a second row;
a first shield comprising:
a plurality of first portions each comprising a recess such that one or more terminals of the first plurality of terminals are disposed therein, and
a plurality of second portions aligned with the first plurality of terminals in a row direction, each of the plurality of second portions connecting adjacent first portions of the plurality of first portions; and
a second shield comprising:
a plurality of first portions each comprising a recess such that one or more terminals of the second plurality of terminals are disposed therein, and
a plurality of second portions aligned with the first plurality of terminals in a row direction, each of the plurality of second portions connecting adjacent first portions of the plurality of first portions.

10. The electrical connector of claim 9, comprising:
a housing comprising a wall elongated in the row direction, the wall comprising a first side and a second side opposite the first side;
the first plurality of terminals are disposed on the first side of the wall; and
the second plurality of terminals are disposed on the second side of the wall.

11. The electrical connector of claim 10, wherein:
the housing comprises a base, the wall protruding from the base, a plurality of first channels extending from the base into the wall in a mating direction perpendicular to the row direction, and a plurality of second channels located within the base and connecting adjacent first channels of the plurality of first channels.

12. The electrical connector of claim 11, wherein:
the housing comprises a plurality of third channels aligned with the plurality of second channels in the row direction; and
the plurality of terminals are at least partially disposed in respective third channels of the plurality of third channels of the housing.

13. The electrical connector of claim 12, wherein:
the plurality of third channels comprise a plurality of pairs of third channels;
each pair of the plurality of pairs of third channels is aligned with a first channel of the plurality of first channels; and
the plurality of third channels comprise one or more third channels offset from the plurality of first channels.

14. The electrical connector of claim 12, wherein:
each of the plurality of terminals comprises a mating contact portion above the base of the housing, a tail extending below the base of the housing; and
each of the plurality of second portions of the first and second shields comprises one or more beams above the base of the housing aligned with the mating contact portions of the plurality of terminals in a respective row of the first and second rows, and one or more tails extending below the base of the housing and aligned with the tails of the plurality of terminals in the respective row of the first and second rows.

15. The electrical connector of claim 12, wherein:
the plurality of first channels comprise a first plurality of first channels and a second plurality of first channels; and
the plurality of second channels comprise a first plurality of second channels located within the base on the first side of the wall and connecting adjacent first channels of the first plurality of first channels, and a second plurality of second channels located within the base on the second side of the wall and connecting adjacent first channels of the second plurality of first channels.

16. The electrical connector of claim 15, wherein:
the plurality of first portions of the first shield are at least partially disposed in respective first channels of the first plurality of first channels of the housing;
the plurality of second portions of the first shield are at least partially disposed in respective second channels of the first plurality of second channels of the housing;
the plurality of first portions of the second shield are at least partially disposed in respective first channels of the second plurality of first channels of the housing; and
the plurality of second portions of the second shield are at least partially disposed in respective second channels of the second plurality of second channels of the housing.

17. The electrical connector of claim 16, wherein:
the plurality of third channels comprise a first plurality of third channels aligned with the first plurality of second channels in row direction on the first side of the wall, and a second plurality of third channels aligned with a second plurality of second channels in the row direction on the second side of the wall;
the first plurality of terminals are at least partially disposed in respective third channels of the first plurality of third channels of the housing; and
the second plurality of terminals are at least partially disposed in respective third channels of the second plurality of third channels of the housing.

18. An electrical connector comprising:
a housing comprising:
a base,
a plurality of walls protruding from the base, each of the plurality of walls elongated in a longitudinal direction, and
a plurality of spaces each between adjacent walls of the plurality of walls;
a plurality of signal terminals disposed along the plurality of walls, each of the plurality of signal terminals comprising a mating contact portion curving into a space of the plurality of spaces; and
a plurality of power terminals symmetrically disposed about a line extending in the longitudinal direction.

19. The electrical connector of claim 18, comprising:
a plurality of shields each comprising:
a plurality of first portions at least partially embedded in a wall of the plurality of walls of the housing and each corresponding to one or more signal terminals disposed along the wall, and
a plurality of second portions aligned with the one or more signal terminals disposed along the wall, each of the plurality of second portions connecting adjacent first portions of the plurality of first portions.

20. The electrical connector of claim 19, comprising:
a power pin and a power receptacle symmetrically disposed about a line extending in the longitudinal direction;
the housing comprises a rib elongated in the longitudinal direction and comprising a slot; and
the power receptacle is disposed in the slot of the rib of the housing and configured to receive a power pin of a mating electrical connector having a mating interface identical to that of the electrical connector.
